(19) United States
(12) Patent Application Publication
(10) Pub. No.: US 2018/0054319 A9
(43) Pub. Date: Feb. 22, 2018

(54) Method, Apparatus, And System For Establishing A Dedicated Communication

(71) Applicant: Issi-Tec Manufacturing Inc., North Vancouver (CA)

(72) Inventor: Reza Yazdiha, North Vancouver British Columbia (CA)

(21) Appl. No.: 14/765,316

(22) PCT Filed: Feb. 4, 2014
(86) PCT No.: PCT/CA14/00084

§ 371 Date: Jul. 31, 2015

Related U.S. Application Data
(60) Provisional application No. 61/760,293, filed on Feb. 4, 2013.
(60) Provisional application No. 61/863,622, filed on Aug. 8, 2013.

(51) Int. Cl. H04L 12/12; H04W 76/02; H04W 12/02; H04L 12/64

(52) U.S. Cl. CPC H04L 12/12; H04L 12/6418; H04W 12/02; H04W 76/021

(57) ABSTRACT

A method implemented on a controller for establishing a dedicated communication with a user interface device is disclosed. The method involves generating a communication identifier, the communication identifier being at least locally unique and having a low probability of being duplicated within a locale associated with the controller. The method also involves transmitting an initiation message including the communication identifier from the controller to the user interface device, the initiation message being operable to initiate a communication session between the controller and the user interface device, the communication identifier identifying the communication session. The method further involves receiving at least one message at the controller including a communication identifier, and associating received messages with the communication session that have a communication identifier that corresponds to the communication identifier identifying the communication session.

### RELATED APPLICATIONS

This application claims the benefit of provisional patent application 61/760,293 entitled NON IDENTITY BASED LINE-OF-SIGHT DEDICATING AND ANTI-INTRUSION INTERSPACED PEER TO PEER DATA COMMUNICATION AND INTERACTIVE INTERFACING METHOD AND SYSTEM BETWEEN AN “ACTIVE-FIXED-CONTROLLER” AND A “PASSIVE-REMOTE-INTERFACING-DEVICE, filed on Feb. 4, 2013 and incorporated herein by reference in its entirety. This application also claims the benefit of provisional patent application 61/863,622 entitled NON IDENTITY BASED LINE-OF-SIGHT DEDICATING AND ANTI-INTRUSION INTERSPACED PEER TO PEER DATA COMMUNICATION AND INTERACTIVE INTERFACING METHOD AND SYSTEM BETWEEN AN “ACTIVE-FIXED-CONTROLLER” AND A “PASSIVE-REMOTE-INTERFACING-DEVICE, filed on Aug. 8, 2013 and incorporated herein by reference in its entirety.

### BACKGROUND OF THE INVENTION

1. Field of Invention

This invention relates generally to communications and more generally to establishing a dedicated data communication between a controller and a user interface device.

2. Description of Related Art

Data communications may be established via a wired or wireless interface between two communication devices for exchanging information. The information to be exchanged may be associated with an interaction between a controller and a user interface device, such as a payment transaction, user selection, or for providing access to a service or restricted area.

For initiation of communications via a wired connection over a shared network and for wireless communications there is a substantial likelihood that other communication devices would be able to receive the communicated data. When initiating wireless communications there is also the possibility of interference between the communication and other communications in the same locale, which may result in corruption of the data being communicated. Common modes of wireless communication typically include measures for dedicating the communication between devices that require a user to make selections and/or enter a password, such as for example IEEE 802.11 and Bluetooth® wireless communications. Such communications use a media access control (MAC) addresses to identify communication data transmitted between devices. The MAC address is a unique fixed identifier associated with a particular device and does not change.

There remains a need for methods that permit dedicated communications to be set up between devices within an environment where several devices may be attempting to communicate simultaneously.

### SUMMARY OF THE INVENTION

In accordance with one aspect of the invention there is provided a method implemented on a controller for establishing a dedicated communication with a user interface device. The method involves generating a communication identifier, the communication identifier being at least locally unique and having a low probability of being duplicated within a locale associated with the controller. The method also involves transmitting an initiation message including the communication identifier from the controller to the user interface device, the initiation message being operable to initiate a communication session between the controller and the user interface device, the communication identifier identifying the communication session. The method further involves receiving at least one message at the controller including a communication identifier, and associating received messages with the communication session that have a communication identifier that corresponds to the communication identifier identifying the communication session.

In accordance with another aspect of the invention there is provided a controller apparatus for establishing a dedicated communication with a user interface device. The apparatus includes an identifier generator operable to generate a communication identifier, the communication identifier being at least locally unique and having a low probability of being duplicated within a locale associated with the controller. The apparatus also includes a transceiver operable to transmit an initiation message including the communication identifier to the user interface device, the initiation message being operable to initiate a communication session between the controller and the user interface device, the communication identifier identifying the communication session. The transceiver is also operable to receive at least one message including a communication identifier. The controller is operable to associate received messages with the communication session that have a communication identifier that corresponds to the communication identifier identifying the communication session.

In accordance with another aspect of the invention there is provided a method implemented on a user interface device for establishing a communication with a controller. The method involves receiving an initiation message from the controller at the user interface device, the initiation message including a communication identifier and being operable to initiate a communication session between the controller and the user interface device. The communication identifier is at least locally unique and having a low probability of being duplicated within a locale associated with the controller. The communication identifier identifies the communication session. The method also involves transmitting at least one message to the controller including a communication identifier corresponding to communication identifier in the initiation message.

In accordance with another aspect of the invention there is provided a user interface device for establishing a communication with a controller. The user interface device includes a transceiver operable to receive an initiation message from the controller, the initiation message including a communication identifier and being operable to initiate a communication session between the controller and the user interface device. The communication identifier is at least locally unique and has a low probability of being duplicated within a locale associated with the controller. The communication identifier identifies the communication session. The transceiver is further operable to transmit at least one message to the controller including a communication identifier corresponding to communication identifier in the initiation message.

Certain embodiments of the invention may have one or more of the following advantages. A dedicated communication session may be set up automatically between a controller and a user interface device without requiring a fixed identifier such as a MCA address. Such fixed identifiers have the disadvantage of potentially being discovered by other users, which may allow interception of communications. Such interceptions may include commonly know attacks such as eavesdropping, man-in-the middle, relay/replay, skimming, phishing, and/or brute force attacks. Where a dedicated communication session has been initiated and established between a controller and a user interface device, other devices may be attempting to intercept the communications using any of the above attack scenarios.

Another advantage of at least some of the disclosed embodiments is that a communication session may be automatically set up between a controller and a user interface device in an environment where other user interface devices may be simultaneously attempting to set up a communication sessions with the same controller or another controller.

In some embodiments, automatic initiation of a dedicated communication session by a controller (i.e. a “pulling” application”) allows the user interface device to connect with the controller, however the user's personal information is only selected and provided in a secure manner by pin code or password entry after the communication session is established.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a communication system for establishing a dedicated communication according to a first embodiment of the invention in which a controller initiates the communication;

FIG. 2 is a schematic view of a communication system for establishing a dedicated communication according to another controller initiated embodiment of the invention;

FIG. 3 is a schematic view of a communication system according to an alternative embodiment of the invention in which the communication is initiated by a proximity signal;

FIG. 4 is a schematic view of a communication system according to an embodiment of the invention in which message encryption is implemented;

Figures is a schematic view of a communication system for establishing a dedicated communication according to an embodiment of the invention in which a user interface device initiates the communication;

FIG. 6 is a schematic view of an alternative embodiment of the communication system shown in FIG. 5;

FIG. 7 is a schematic view of an alternative embodiment of the communication system shown in FIG. 1;

FIG. 8 is a block diagram of a controller processor circuit for implementing any of the controllers of FIGS. 1-7;

FIG. 9 is a block diagram of a user interface device processor circuit for implementing any of the user interface devices of FIGS. 1-7;

FIG. 10 is a block diagram of a transceiver used in either of the processor circuits of FIG. 8 and FIG. 9;

FIG. 11 is an optical data transmitter embodiment for use in the transceiver shown in FIG. 10;

FIG. 12 is a radio frequency (RF) data transmitter embodiment for use in the transceiver shown in FIG. 10;

FIG. 13 is an example of a message format for messages transmitted by either of the processor circuits of FIG. 8 and FIG. 9;

FIG. 14A is a process flowchart depicting blocks of codes for directing the controller processor circuit of FIG. 8 to initiate a communication session;

FIG. 14B is a process flowchart depicting blocks of codes for directing the user interface device processor circuit of FIG. 9 to respond to the initiation of the communication session by the controller processor circuit;

FIG. 15 is schematic view of an embodiment of the controller processor circuit of FIG. 8 and the user interface device processor circuit of FIG. 9 in an access control system;

FIG. 16A and FIG. 16C is a process flowchart depicting blocks of codes for directing the controller processor circuit of FIG. 8 to implement an access control system for parking;

FIG. 16B and FIG. 16D is a process flowchart depicting blocks of codes for directing the user interface device processor circuit of FIG. 9 to interact with an access control system for parking;

FIG. 17 is a block diagram of a communication system embodiment in which the user interface device is implemented on a mobile device;

FIG. 18A is a process flowchart depicting blocks of codes for directing the controller processor circuit of FIG. 8 to respond to a request for initiation of a communication session from a user interface device;

FIG. 18B is a process flowchart depicting blocks of codes for directing the user interface device processor circuit of FIG. 9 to request initiation of a communication session with a controller;

FIG. 19 is a process flowchart depicting blocks of codes for directing either of the processor circuits of FIG. 8 and FIG. 9 to implement a receive timeout/countout process;

FIG. 20A and FIG. 20B are respective portions of a table listing possible mode codes used in the messages shown in FIG. 13;

FIG. 21A and FIG. 21B is a process flowchart depicting blocks of codes for directing the controller processor circuit of FIG. 8 to process a payment submitted by a user interface device;

FIG. 21C is a process flowchart depicting blocks of codes for directing the user interface device processor circuit of FIG. 9 to interact with the controller processor circuit of FIG. 9 for submission of a payment;

FIG. 22A is a process flowchart depicting blocks of codes for directing the controller processor circuit of FIG. 8 to finalize a communication session;

FIG. 22B is a process flowchart depicting blocks of codes for directing the controller processor circuit of FIG. 8 to execute a finalization process;

FIG. 23A is a process flowchart depicting blocks of codes for directing the user interface device processor circuit of FIG. 9 to finalize a communication session;

FIG. 23B is a process flowchart depicting blocks of codes for directing the user interface device processor circuit of FIG. 9 to execute a finalization process;

FIG. 24 is a table of exemplary messages transmitted by either of the processor circuits shown in FIG. 8 or FIG. 9; and

FIG. 25 is a process flowchart depicting blocks of codes for directing either of the processor circuits of FIG. 8 and FIG. 9 to implement a multiple transceiver embodiment.

### DETAILED DESCRIPTION

### System Overview

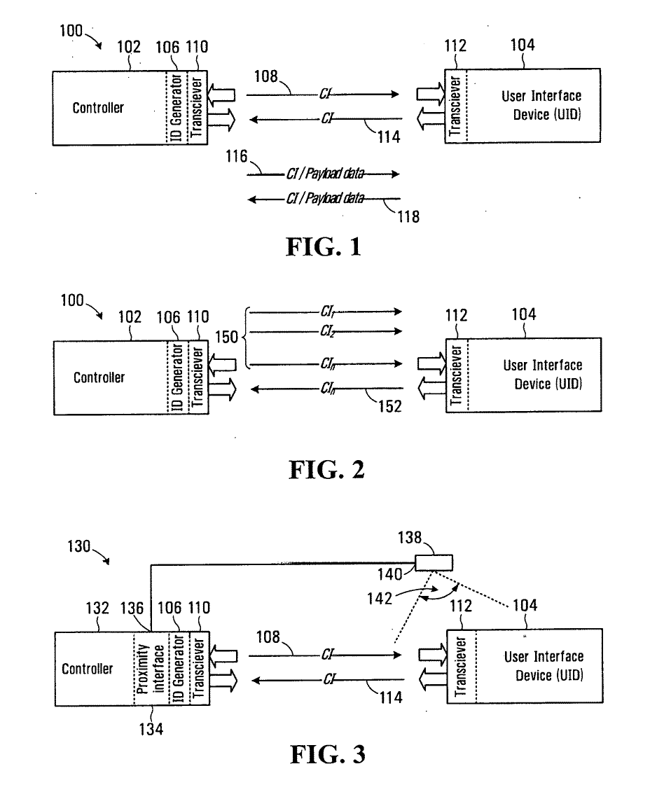

Referring to FIG. 1, a communication system for establishing a dedicated communication according to a first embodiment of the invention is shown generally at 100. The system 100 includes a controller apparatus 102 and a user interface device 104.

The controller 102 includes an identifier generator 106 operable to generate a communication identifier (CI). The generated communication identifier is at least locally unique and has a low probability of being duplicated within a locale associated with the controller 102. For example the communication identifier may be a random number that has sufficient digits such that the possibility of another controller within the locale selecting the same identifier (i.e. duplicating the communication identifier) within the time period of the dedicated communication is extremely unlikely. The random communication identifier may be generated by the controller in a random number generator, selected from a table of random numbers generated in advance, or may be obtained from a random number server in communication with the controller over a network. Alternatively, the controller 102 may include a real time clock (not shown) and the communication identifier may be based on a time and/or date provided by real-time clock. In other embodiments, the time/date may be provided to the controller by a time server in communication with the controller over a network. As an example, system clocks in conventional computing equipment provide a time presented as a year/month/day/hour/minute/second/one hundredth seconds value, and a time based identifier having a one hundredth second time resolution would have a negligibly low chance of being duplicated within the locale of the controller 102 within any 24 hour period. Similarly, adding a date to the time based communication identifier would extend the uniqueness of the communication identifier beyond the 24 hour period.

The controller 102 also includes a transceiver 110 operable to transmit an initiation message 108 including the communication identifier to the user interface device 104. The initiation message 108 is operable to initiate a communication session between the controller 102 and the user interface device 104, where the communication identifier identifies the communication session. Since the communication identifier is locally unique, the communication identifier should uniquely identify the communication session from other communication sessions taking place in the same general locale (such as a communication session initiated by another controller disposed in the same locale).

The user interface device 104 includes a transceiver 112 operable to receive the initiation message 108 including the communication identifier from the controller 102. The transceiver 112 is also operable to transmit at least one message 114 to the controller 102. The message 114 includes a communication identifier corresponding to communication identifier in the initiation message 108.

The transceiver 110 of the controller 102 is further operable to receive the message 114. The controller 102 is operable to associate received messages (such as the message 114) with the communication session that have a communication identifier that corresponds to the communication identifier identifying the communication session.

Additional messages 116 and 118 may subsequently be transmitted between the controller 102 and the user interface device 104. The additional messages 116 and 118 may include payload data related to an interaction between a user of the user interface device 104 and the controller 102, such as a user selection, data transfer related to a financial transaction, access to a restricted area, and/or other interactions.

In general, the controller communication will be established between the controller 102 and the user interface device 104 in response to a signal that in the communication system 100 the initiation message 108 is shown controller 102

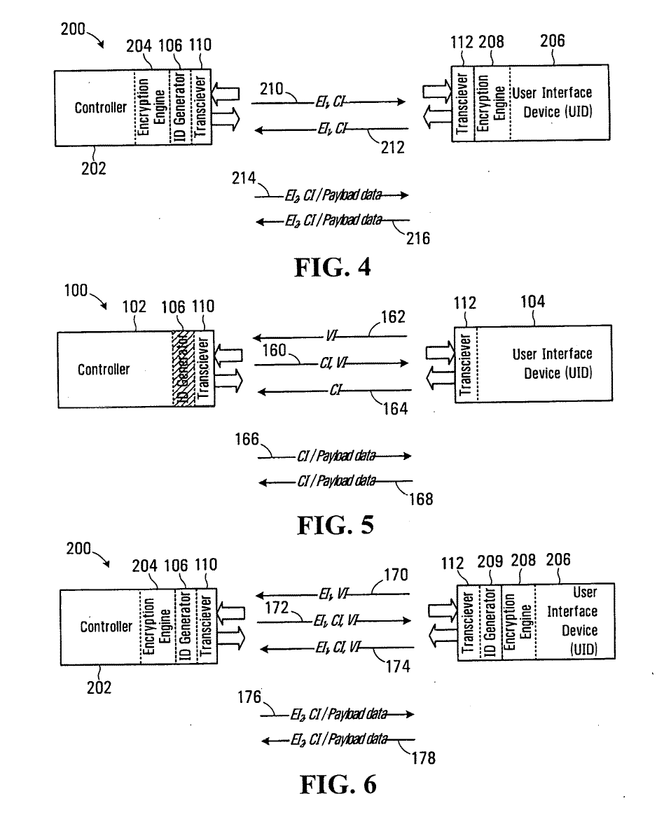

Communication initiated by controller Referring to FIG. 2, in one embodiment the controller 102 of the system 100 shown in FIG. 1 may be configured to generate successive initiation messages 150, each having a newly generated communication identifier (i.e. CI₁, CI₂, . . . CIₙ). The successive messages 150 may be transmitted by the transceiver 110, at successive times separated by a delay time commensurate with a time taken for the user interface device 104 to respond to the initiation message 150. When the transceiver 112 of the user interface device 104 is in range for receiving the messages 150, the user interface device causes the transceiver to transmit the message 152 back to the controller 102. In response to receiving the message 152, a communication session is established between the controller 102 and the user interface device 104 and is identified by the communication identifier CIₙ transmitted in the last transmitted initiation message 150. The controller 102 then discontinues sending the successive initiation messages 150. In this embodiment the initiation messages 150 are thus continuously transmitted by the controller 102 until a user interface device 104 transmits the message 152 back to the controller.

In other embodiments, the controller 102 (shown in FIG. 1) may respond to an initiation signal prior to sending the initiation message 108.

### Initiated by Proximity Signal

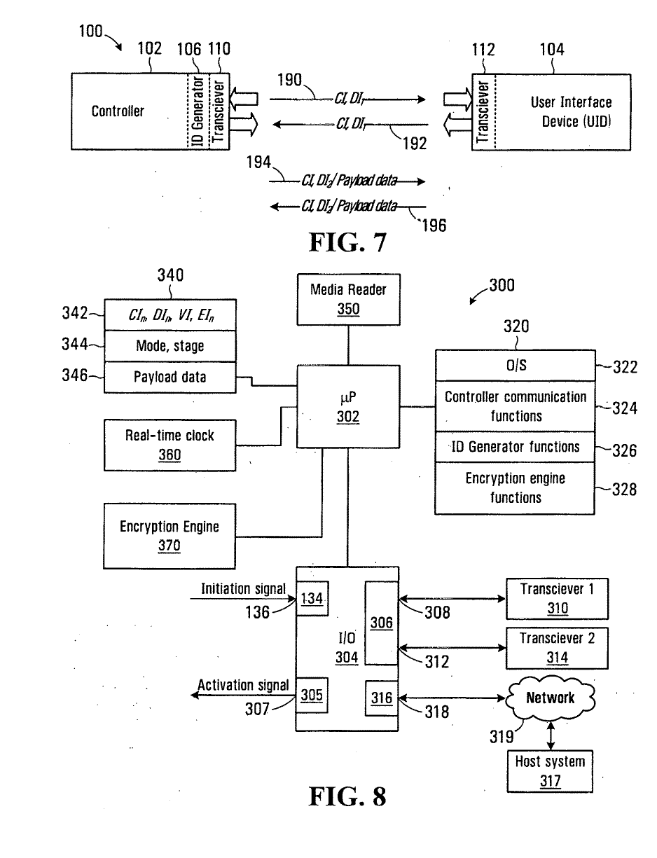

An alternative embodiment of the system in which the controller receives an initiation signal is shown in FIG. 3 at 130. Referring to FIG. 3, the system 130 includes the user interface device 104 shown in FIG. 1 and a modified controller 132. The controller 132 includes the identifier generator 106 and the transceiver 110 included in the controller 102 shown in FIG. 1, but further includes a proximity interface 134 having an input 136. The system 130 also includes a proximity detector 138 having an output 140, which is in communication with the input 136 of the proximity interface 134. The proximity detector 138 is disposed to detect a body (not shown) entering a region 142 defined with respect to the controller 132, and to produce an initiation signal at the output 140 indicating that the body is either in or about to enter into communication range. The body may be a person or a vehicle carrying the user interface device 104. Alternatively the proximity detector 138 may detect the presence of the user interface device 104 within the region 142.

The controller 132 generates the initiation message 108 in response to receiving the signal produced by the proximity detector 138 at the input 136 of the proximity interface 134. The initiation message 108 is therefore only generated when a body and/or user interface device 104 is within communication range and the proximity detector 138 produces the initiation signal.

### Encryption

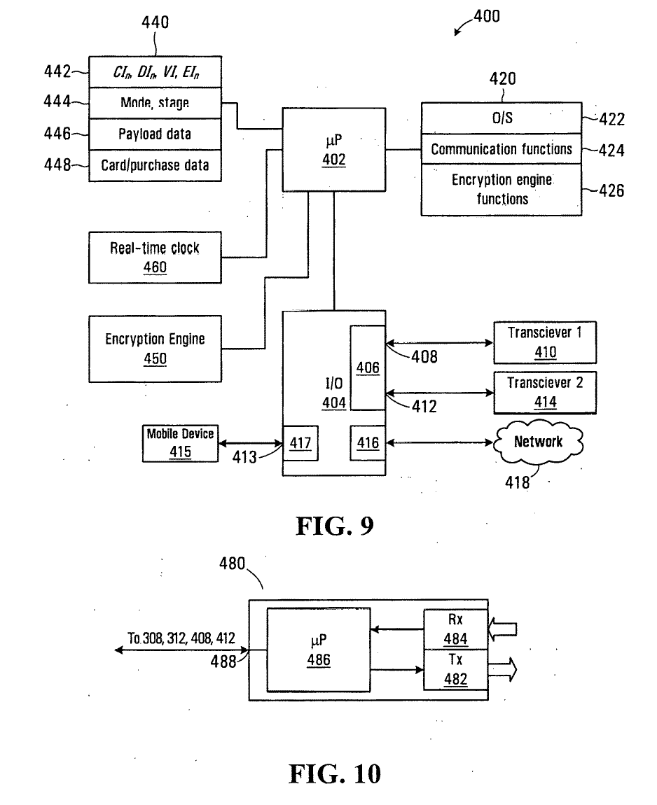

An alternative embodiment of the system in which the controller implements encryption of transmitted messages is shown in FIG. 4 at 200. Referring to FIG. 4, the system 200 includes a modified controller 202. The controller 202 includes the identifier generator 106 and the transceiver 110 included in the controller 102 shown in FIG. 1, but further includes an encryption engine 204. The 200 system also includes a modified user interface device 206 including an encryption engine 208, and an ID generator 209. The encryption engines 204 and 208 implement encryption and decryption functions on the respective controller 202 and user interface device 206 for increasing the security of the dedicated communication session.

In this embodiment, the controller 202 transmits an initiation message 210 that includes encryption information, in this case in the form of an encryption identifier EI₁. In this embodiment, the encryption identifier is used to identify one of a plurality of pre-defined encryption functions used by the encryption engine 204 to encrypt the message 210. For example, the encryption functions may include functions for performing a re-ordering operation for changing an order of information in the message or a mathematical operation to be performed on data representing the information. Other known unchangeable encryption functions may be implemented on user interface devices and controllers. The encryption function may be selected used and introduced by either the user interface device of the controller and subsequently used, followed and reintroduced by the other throughout a communication session. Each encryption function may perform a combination of operations including, for example at least one re-ordering operation and at least one mathematical operation. A plurality of pre-defined encryption functions may be pre-associated with encryption identifiers EI₁ to EIₙ and each of the controller 202 and the user interface device 206 will have corresponding information defining the encryption functions and their respective identifiers.

In one embodiment, the controller 202 generates contents for inclusion in the message 210. The encryption engine 204 then randomly selects an encryption function EI₁ for encrypting the message contents for the message 210. The selected encryption function EI₁ is then used by the encryption engine 204 to encrypt the contents of the message. For the message 210, the communication identifier CI is thus encrypted and the unencrypted encryption identifier EI₁ is added to produce the message 210, which is transmitted by the transceiver 110 to the user interface device 206.

The user interface device 206 receives the message 210, reads the encryption identifier EI₁, and the encryption engine 208 selects a corresponding decryption function for decrypting the message 210 to reveal the communication identifier CI. The user interface device 206 then generates the message 212 using the same encryption function EI₁, which is again added to the message 210 in unencrypted form.

In this embodiment, the encryption engine 204 of the controller 202 changes the encryption function and transmits an additional message 214 using an encryption identifier EI₂. The encryption engine 204 of the controller 202 thus selects the encryption function for each successive message transmitted to the user interface device 206, which uses the same encryption function when responding to the message 214 by transmitting a further message 216. The encryption function may again be changed by the controller 102 for further messages transmitted to the user interface device 104. Changing the encryption function helps with eliminating the possibility of the dedicated communication being breached, since patterns between successive messages will differ even if there is repeated message content due to the encryption. In other embodiments, the encryption function may be changed less frequently, or may be in effect for the entire communication session for communication applications where security is less of a concern.

Communication Initiated by Request from User Interface Device

Referring to FIG. 5, in an another embodiment the controller 102 of the system 100 shown in FIG. 1 may be additionally configured to send an initiation message 160 in response to receiving an initiation signal in the form of an initiation request message 162 transmitted by the transceiver 112 of a user interface device 104. The initiation request message 162 is operable to cause the controller 102 to send the initiation message 160, thus facilitating establishment of a dedicated communication between the user interface device 104 and the controller.

In one embodiment the user interface device 104 may generate a verification identifier VI for inclusion in the initiation request message 162. The verification identifier VI may be a previously received communication identifier CI from a prior communication session with the controller 102 or another controller, and in this case generation of the VI may involve reading the previously received communication identifier CI. Alternatively, the user interface device 104 may include an identifier generator similar to the identifier generator 106 of the controller 102 and the verification identifier VI may be generated in a similar manner to the communication identifier CI.

In this embodiment, the verification identifier VI provided in the initiation request message 162 by the user interface device 104 is used in the initiation message 160 transmitted by the controller 102, which includes a communication identifier (CO generated by the controller 102 and the verification identifier provided by the user interface device. The user interface device 104 is able to use the verification identifier to verify that the initiation message 160 was sent in response to the initiation request message 162, and not in response to a message from another user interface device in communication range of the controller 102. In the embodiment shown, the user interface device 104 responds to the initiation message 160 by sending a further message 164 including the communication identifier CI. In this embodiment the VI is not transmitted in the message 164, since the user interface device 104 will have already verified that the initiation message 160 was sent in response to the initiation request message 162. Subsequent messages 166 and 168 may be transmitted between the controller 102 and the user interface device 104. In this embodiment, the subsequent messages 166 and 168 include payload data but also do not necessarily include the verification identifier which is only used while establishing the communication session. In other embodiments the VI may be included in the message 164 and subsequent messages 166 and 168 to provide an additional level of security for the dedicated communication session. If another user interface device were to request initiation of a communication session at about the same time as the user interface device 104, the locally unique verification identifier would be different and the user interface device 104 would disregard the initiation message 160 transmitted by the controller 102.

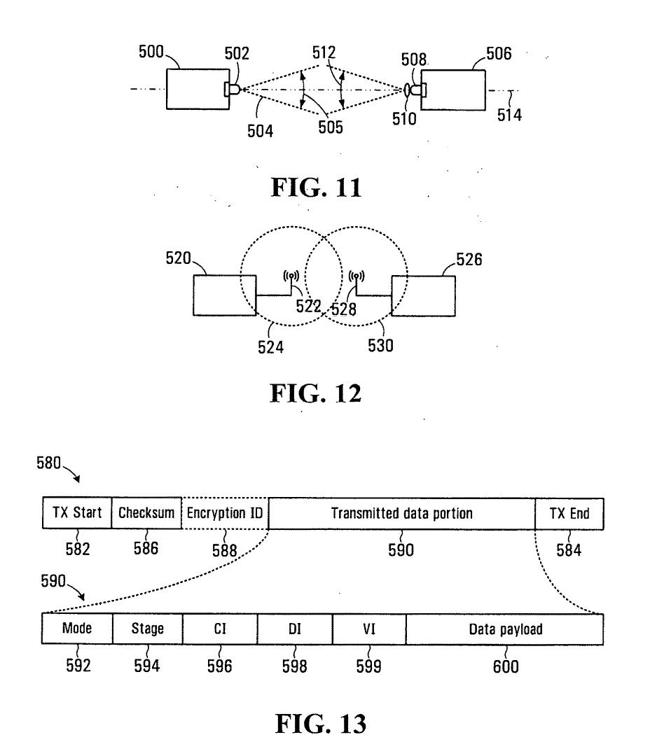

As described above in connection with FIG. 4, messages between the controller 202 and the user interface device 206 may be encrypted to increase the security of the dedicated communication session. Encryption may be implemented in the embodiment shown in FIG. 5 to improve security of the dedicated communication session. Referring to FIG. 6, in alternative to the embodiment shown in FIG. 6 the system 200 including the controller 202, user interface device 206, and respective encryption engines 204 and 208 are implemented to provide encryption for a user interface device initiation request message 170 sent to the controller 202 to request initiation of the communication session. In this embodiment the user interface device 206 is configured to send an initiation signal in the form of the initiation request message 170 including the verification identifier VI as described above with reference to FIG. 5. The initiation request message 170 further includes encryption information, in this case in the form of an encryption identifier EI₁. The encryption identifier is used to identify one of a plurality of pre-defined encryption functions used to encrypt the initiation request message 170, as described above in connection with the embodiment of FIG. 4. In this embodiment, the user interface device 206 generates the contents of the initiation request message 170 and then randomly selects an encryption function EI₁ for encrypting the message. The encryption identifier EI₁ is used to encrypt the contents of the initiation request message 170 including the verification identifier and the unencrypted encryption identifier EI₁ is added to the message. The controller 202 receives the initiation request message 170, reads the encryption identifier EI₁, and selects the appropriate encryption function for decrypting the message to reveal the verification identifier VI. The controller then generates contents for an initiation message 172 including a communication identifier CI and the verification identifier VI and encrypts the message using the same encryption identifier EI₁, which is again added to the message in unencrypted form. The same process is repeated by the user interface device 206, which generates the message 174 including the communication identifier CI and the verification identifier VI and encrypts the message using the encryption identifier EI₁, which is added to the message in unencrypted form. If the user interface device 206 were to receive an initiation message having a different function number rather then the message 172, the user interface device would be able to determine that the initiation message was not transmitted in response to the initiation request message 170 and may disregard the message or send another initiation signal message having a new verification identifier and/or new encryption identifier.

Once the communication session between the controller 202 and the user interface device 206 has been established, the controller may change the encryption function and transmit additional messages using an encryption function identified by the encryption identifier EI₂. In the embodiment shown the controller thus generates the contents of the message 176 including the communication identifier CI and payload data encrypted in accordance with the encryption function identified by the encryption identifier EI₂, which is included in the message 176 in unencrypted form. In this embodiment, after the communication session has been established the controller 202 selects the encryption function for the message 176 and the user interface device uses the same encryption function when responding to the message 176 by transmitting the message 178. The encryption function may again be changed by the controller 202 for further messages transmitted to the user interface device 206. When the user interface device requests initiation of a communication, the user interface device exceptionally selects the encryption function, which is copied and used during initiation of the communication session. Following initiation, the controller selects the encryption function.

### Dynamic Identifiers

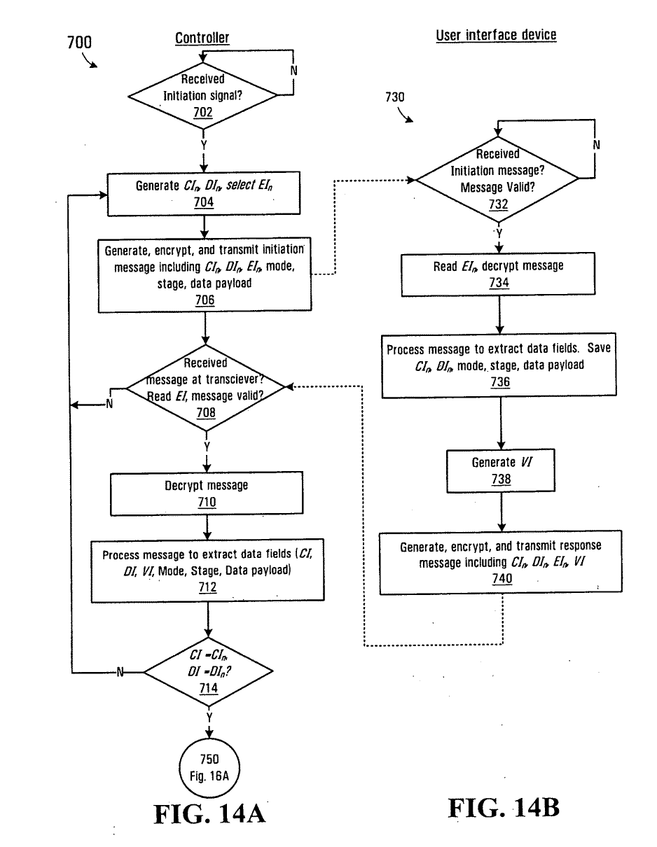

Referring to FIG. 7, in another embodiment the controller 102 of the system 100 shown in FIG. 1 may be configured to generate an additional identifier that has a value that changes as the communication session progresses. In this embodiment an initiation message 190 includes the communication identifier as described above and further includes a dynamic identifier DI₁ that changes as the communication session progresses. For example, in one embodiment the dynamic identifier may change with elapsed time.

The user interface device 104 receives the initiation message 190 including the dynamic identifier DI₁ and transmits a message 192 back to the controller 102 that includes the communication identifier CI and the dynamic identifier DI₁.

The message 192 is received by the transceiver 110 of the controller 102, which determines whether the communication identifier CI matches the communication identifier for the communication session. However, the controller 102 also determines whether the dynamic identifier DI₁ in the received message 192 corresponds to a current value of the dynamic identifier (i.e. DI₁) transmitted by the controller in the initiation message 190. The message 192 is associated with the communication session only if both the communication identifier CI and the dynamic identifier DI₁ both match the respective identifiers for the communication session.

The controller 102 then generates a new dynamic identifier DI₂ for transmission of an additional message 194 to the user interface device 104. The message 194 thus includes the communication identifier CI, the dynamic identifier DI₂, and payload data associated with an interaction between the controller 102 and the user interface device 104. The user interface device 104 again responds by including the dynamic identifier DI₂ in the message 196 transmitted back to the controller 102. Subsequent messages transmitted by the controller 102 would include further dynamic identifiers, for example DI₃, DI₄ . . . DIₙ.

The use of the dynamic identifier provides an additional level of security for maintaining the communication as a dedicated communication session between the controller 102 and the user interface device 104. Additionally, when the communication is encrypted as described above with reference to FIG. 6, the communication identifier and dynamic identifier will both be encrypted.

In one embodiment the dynamic identifiers DI₁, DI₂, DI₃, DI₄ . . . DIₙ may be generated by the identifier generator 106 of the controller apparatus 102. As in the case of the communication identifier, the dynamic identifier should be at least locally unique and have a low probability of being duplicated within a locale associated with the controller 102. In one embodiment the dynamic identifiers may be a time-based identifier, which is generated based on reading a real time clock prior to each transmission of the messages 190, 194, and subsequent messages to the user interface device 104. In other embodiments, the dynamic identifiers may be random numbers either generated by the identifier generator 106 of the controller apparatus 102 or obtained from a random number server (not shown). The random numbers may be maintained in a memory of the identifier generator 106 as a list including a plurality of previously generated numbers that are used to provide the successive changing dynamic identifiers.

In this embodiment through the usage of the dynamic identifier DI and the associated usage of the communication identifier CI, which differ for different communication sessions, and through encryption of the message content, no two sequential request and responses can be relayed and memorized from one communication session and replayed in any other communication sessions. For this reason, an eavesdropper having the ability to relay and memorize communicated messages of a communication session, would still not be successful in the replaying the same memorized messages of the user interface device to implement a fraud session duplication.

For a user interface device initiated communication, the communication initiation includes the initiation request message transmitted by the user interface device, the initiation message transmitted by the controller, and the response transmitted by the user interface device. When the user interface device requests initiation of a communication session, and selects a dynamic identifier DI (as described above) for use in the communication initiation, an additional measure of security is provided through the use of the dynamic identifier by the user interface device.

Additionally, the controller and the user interface device should be configured to prohibit selection of a common encryption identifier EI for two successive messages having the same content (for example, a suspend message described later herein). In such cases if the dynamic identifier DI were time based, as described above, subsequent repeating messages may only differ at the 1/100 second level, thus only have a single byte that differs which may compromise the security of the communication. In some embodiments messages may be transmitted at a rate of about 50 messages per second, making such a condition a possibility. As long as the repeated messages are encrypted using different encryption functions, the difference between repeated messages will be more than a single byte and the message will be secure. Consequently, repeated initiation request messages from a user interface device or other repeating messages are transmitted using different encryption functions to prevent discovery of the message functionality or encryption functions used by the user interface device. This results from n numbers of a repeating message in one second resulting in n+1 unknowns, which is not solvable by any cryptanalytic apparatus.

Furthermore an identical communication session, may be repeated at different times by the usage of communication identifier CI, verification identifier VI and dynamic identifier DI. In this case, even if a plurality of a specific messages in a specific sequence of a specific session containing information are relayed and memorized by a eavesdropper apparatus, no discovery of the functionality of any implemented encryption functions is possible, since there are at least 3n+1 unknowns, which is not solvable by any cryptanalytic apparatus.

Additionally, if through knowledge of the location of the encryption identifier EI in the message, a group of memorized messages that contain a unique encryption identifier are selected and analysed by a cryptanalytic apparatus, no discovery of the functionality of any used encryption functions would be possible because there are always at least 3n+1 unknowns, which is not solvable by any cryptanalytic apparatus.

For example, if a session was memorized by an eavesdropper apparatus that has the ability to relay and memorize all of the communicated messages of the communication session, and then replay the memorized messages to implement a fake session simulation with the same original or other controllers. The use of different communication identifier CI and different verification identifiers VI, which are not available to an eavesdropper, would make a fraudulent duplication of the dedicated communication impossible.

In the above disclosed embodiments described with reference to FIG. 1-FIG. 7, various disclosed features of each embodiment may be included with other embodiments. For example, in the embodiment of FIG. 1, the message 114 transmitted by the user interface device 104 may include the verification identifier described in connection with FIG. 5. Similarly, in the embodiment of FIG. 3 that includes a proximity detector 138, the verification identifier described in connection with FIG. 5 may be included in the message 114. The dynamic identifiers disclosed in the embodiment of FIG. 7, may also be included in any of the embodiments of FIG. 2 to FIG. 6. The proximity interface 134 and proximity detector 138 shown in FIG. 3 may be implemented in any of the embodiments for FIG. 2, FIG. 5, FIG. 6 and/or FIG. 7.

In one embodiment the controller 102 shown in FIGS. 1, 2, 5, and 7, the controller 132 shown in FIG. 3, and the controllers 204 shown in FIGS. 4 and 6 may be implemented using a configurable processor circuit. In other embodiments the various controllers may be implemented using logic circuits, application specific integrated circuits, and/or field programmable gate array circuits, for example.

Similarly, the user interface device 104 shown in FIGS. 1, 2, 3, 4, and 7, the user interface device 206 shown in FIG. 4 and FIG. 6 may be implemented using a configurable processor circuit. The user interface devices 104 and/or 206 may be implemented on portable devices such as a smart phone, tablet computer, or other handheld computing device, laptop or desktop computer, vehicle communications interface, or remote control device. In other embodiments the various user interface devices may be implemented using logic circuits, application specific integrated circuits, and/or field programmable gate array circuits, for example.

Referring back to FIG. 6, in the embodiment shown the user interface device initiation request message 170 may further include a dynamic identifier that that changes as the communication session progresses, as describe above. However in this case the dynamic identifier may be a dynamic identifier DI₀ generated by the user interface device 104 and transmitted in each of the messages 162, 160, and 164. After the communication session is established, the dynamic identifier DI₀ is dropped form subsequent messages 166 and 168 and is replaced by a dynamic identifier DI₁ generated and updated by the controller 102.

### Controller Processor Circuit

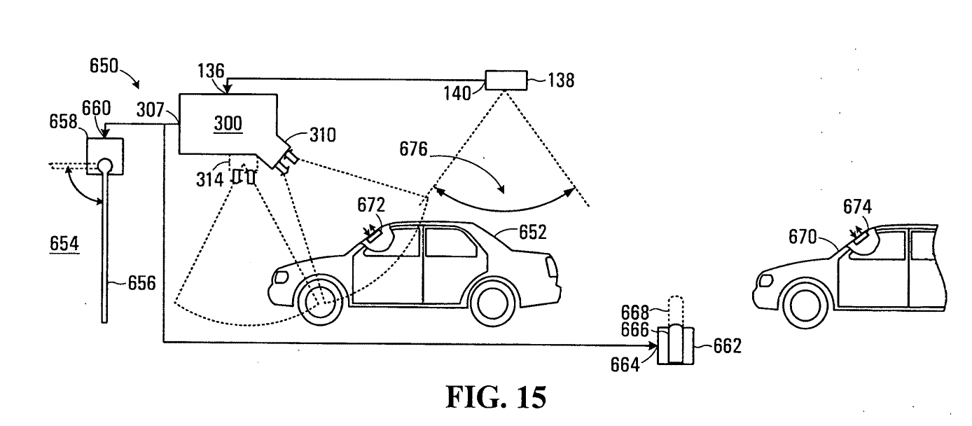

Referring to FIG. 8, a controller processor circuit embodiment for implementing any of the controllers 102, 132, and/or 202 is shown generally at 300. The processor circuit 300 includes a microprocessor 302, an input output port (I/O) 304, a program memory 320, a variable memory 340, a media reader 350, a real-time clock 360, and an encryption engine 370, all of which are in communication with the microprocessor 302.

Program codes for directing the microprocessor 302 to carry out various functions are stored in the program memory 320, which may be implemented as a random access memory (RAM), flash memory, and/or a hard disk drive (HDD), or a combination thereof. The program memory 320 includes a first block of program codes 322 for directing the microprocessor 302 to perform operating system functions, a second block of program codes 324 for directing the microprocessor 302 to perform controller communication functions, a third block of program codes 326 for directing the microprocessor 302 to perform identifier generator functions, and fourth block of program codes 328 for directing the microprocessor 302 and/or encryption engine 370 to perform encryption functions.

The I/O 304 includes a plurality interfaces including a transceiver bus interface 306, which includes an input/output port 308 for interfacing with a first transceiver 310 and an input/output port 312 for interfacing with a second transceiver 314. In other embodiments, more than two transceivers may be implemented. The I/O 304 also includes a network interface 316 for interfacing with a host system. In one embodiment the network interface 316 is an Ethernet interface having an Ethernet port 318 for connecting the processor circuit 300 to a host system 317 over a network 319 such as the internet. The I/O 304 also includes the proximity interface 134 and the input 136 for receiving the initiation signal from the proximity detector 138 (shown in FIG. 3). In this embodiment the I/O 304 further includes an actuator interface 305 having an output 307 for generating one or more activation signals, which may be used to open a gate or a door, for example.

The media reader 350 facilitates loading program codes into the program memory 320 from a computer readable medium 352, such as a CD ROM disk 354 or a portable media device such as a USB data storage device, for example. Program codes may also be received from a host system or other connected system via the network interface 316 and loaded into the program memory 320.

In one embodiment the encryption engine 370 may be implemented as a dedicated encryption integrated circuit device in communication with the microprocessor 302, which may include on-board memory for storing encryption functions and corresponding encryption identifiers. In other embodiments the encryption engine 370 may be implemented by causing the encryption program codes 328 to be executed by the microprocessor 302.

The variable memory 340 includes a plurality of storage locations including a first location 342 for storing values of the various identifiers such as CIₙ, DIₙ, VI, EIₙ, a second location 344 for storing mode codes and stage codes (described later herein), and a third location 346 for storing a data payload extracted from received messages. The variable memory 340 may be implemented in random access memory, for example.

### User Interface Device Processor Circuit

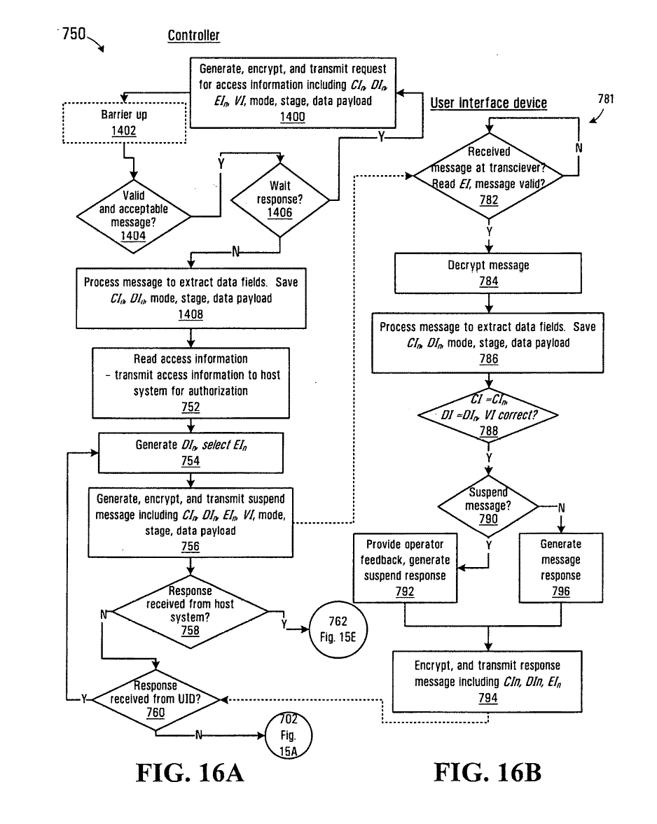

Referring to FIG. 9, a user interface device processor circuit embodiment for implementing the user interface devices 102 and/or 206 is shown generally at 400. The processor circuit 400 includes a microprocessor 402, an input output port (I/O) 404, a program memory 420, a variable memory 440, and an encryption engine 450, all of which are in communication with the microprocessor 402. The processor circuit 400 also includes a real-time clock 460 in communication with the microprocessor 402. The real time clock may be used to generate the dynamic identifier DI₀ that changes as the communication session progresses, as described above.

Program codes for directing the microprocessor 402 to carry out various functions are stored in the program memory 420, which may be implemented as a random access memory (RAM), flash memory, and/or a hard disk drive (HDD), or a combination thereof. The program memory 420 includes a first block of program codes 422 for directing the microprocessor 402 to perform operating system functions. For example in one embodiment where the user interface device is implemented using a smart phone or tablet computer, the operating system may be a mobile operating system, such as the Android™ mobile operating system for example. The program memory 420 includes a second block of program codes 424 for directing the microprocessor 402 to perform controller communication functions, a third block of program codes 426 for directing the microprocessor 402 to and/or encryption engine 450 to perform encryption functions.

The I/O 404 includes a plurality interfaces including a transceiver bus interface 406, which includes and input/output port 408 for interfacing with a first transceiver 410 and an input/output port 412 for interfacing with a second transceiver 414. In other embodiments, more than two transceivers may be implemented. The I/O 404 may also include an interface 417, having a port 413 for interfacing with a mobile device 415, such as a mobile phone or other handheld device. The I/O 404 may also include a network interface 416 for interfacing with a network 418, such as the internet. In one embodiment the network interface 416 is a wireless interface such as an IEEE 802.11 g wireless local area network (WLAN) communications interface for interfacing with a wireless hotspot, or a wireless data interface such as a 3G or 4G interface for communicating with a data telecommunication network. Program codes for configuring user interface device functionality may be received via the network interface 416 and loaded into the program memory 420.

The variable memory 440 includes a plurality of storage locations including a first location 442 for storing values of the various identifiers such as CIₙ, DIₙ, VI, EIₙ, a second location 444 for storing mode codes and stage codes (described later herein), a third location 446 for storing a data payload extracted from received messages, and a fourth location 448 for storing a card and/or purchase data. The variable memory 440 may be implemented in random access memory, for example.

The encryption engine 450 may be implemented as a dedicated encryption integrated circuit device in communication with the microprocessor 402, which may include on-board memory for storing encryption functions and corresponding encryption identifiers. In other embodiments the encryption engine 450 may be implemented by causing the encryption program codes 426 to be executed by the microprocessor 402.

### Transceivers

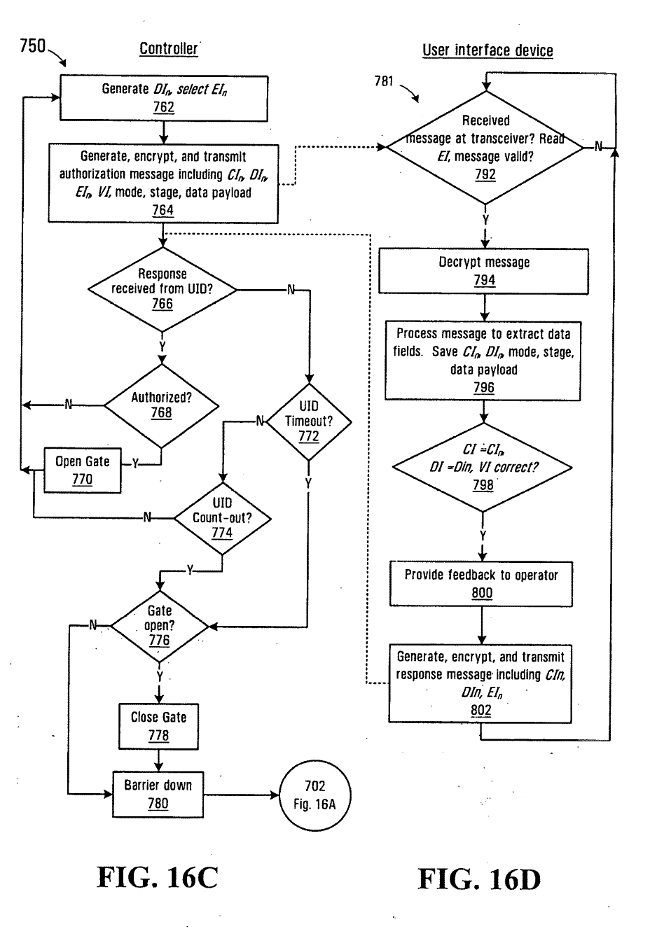

A transceiver embodiment for implementing any of the transceivers 310,314,410,414 shown in FIG. 8 or FIG. 9 is shown at 480 in FIG. 10. Referring to FIG. 10, the transceiver 480 includes a transmitter 482 and a receiver 484. In this embodiment the transceiver 480 also includes a microprocessor circuit 486. The transceiver 480 also includes an input/output port 488, coupled to the microprocessor circuit 486. The input/output port 488 is coupled to one of the input/output ports 308, 312, 408, or 412 of the respective processor circuits 300 and 400 (shown in FIG. 8 and FIG. 9), and the transceiver bus interfaces 306 and 406 are operable to write data to be transmitted and read data received via the bus interface. In other embodiments the transceiver 480 may have two or more transceivers, each having respective transmitters and receives. Transmission data received via the transceiver bus interfaces 306, 406 is received by the microprocessor circuit 486 at the input 488, which encodes the transmission data on an encoded data signal for driving the transmitter 482. Similarly, encoded data signals received by the receiver 484 are decoded by the microprocessor circuit 486 to recover the data, which is then written back to the processor circuits 300 and 400 via the bus interfaces 306, 406.

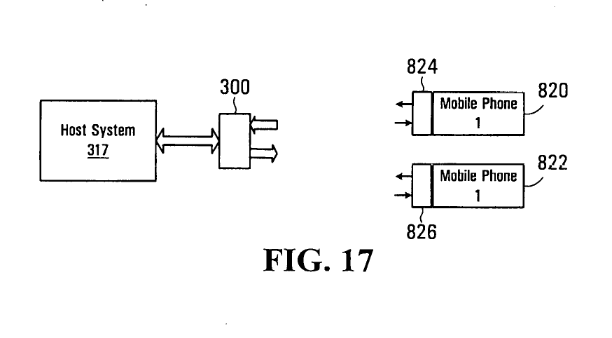

The microprocessor circuit 486 permits several transceivers 480 to be coupled to the processor circuits 300 and 400 via the respective bus interfaces 306 and 406. In other embodiments the microprocessor circuit 486 may be omitted and the bus interfaces 306 and 406 may be configured to produce encoded data signals for transmission by the transmitter 482 and to receive and decode the encoded data signals from the receiver 484. Referring to FIG. 11, in one embodiment the transmitter 482 of the transceiver 480 may be implemented using an optical data transmitter 500 for transmitting optically encoded data signals. The optical data transmitter 500 includes an optical transmitter element 502, such as an infrared light emitting diode that generates a beam of infrared light having a radiation pattern 504 that is constrained within a transmission angle range 505. The light produced by the optical transmitter element 502 is modulated to carry the transmission data.

Similarly, the receiver 484 of the transceiver 480 may be implemented using an optical data receiver 506 for receiving optically encoded data signals. In FIG. 11, the optical data receiver 506 is shown disposed to receive optical data signals transmitted by the optical data transmitter 500, but in practice each transceiver 480 will include a proximately disposed transmitter and receiver as shown in FIG. 10. The optical data receiver 506 includes an optical detector 508, such as a photo-diode that generates signal in repose to light impinging on the detector. In this embodiment, the detector 508 includes a lens 510 for gathering light radiation within a constrained acceptance angle range 512.

In FIG. 11, the transmitter 500 and receiver 506 are directed toward each other and aligned along an axis 514. However if the transmitter 500 and/or the receiver 506 are directed sufficiently away from the axis 514, a transmission by the transmitter may not reach the receiver. The transmitter 500 and receiver 506 thus need to be sufficiently aligned to permit the data transmission to proceed. The constrained transmission angle range 505 and the receiving angle range 512 provide an additional measure of security for establishing the dedicated communication session, since the transmitter 500 and receiver 506 need to be sufficiently aligned to communicate.

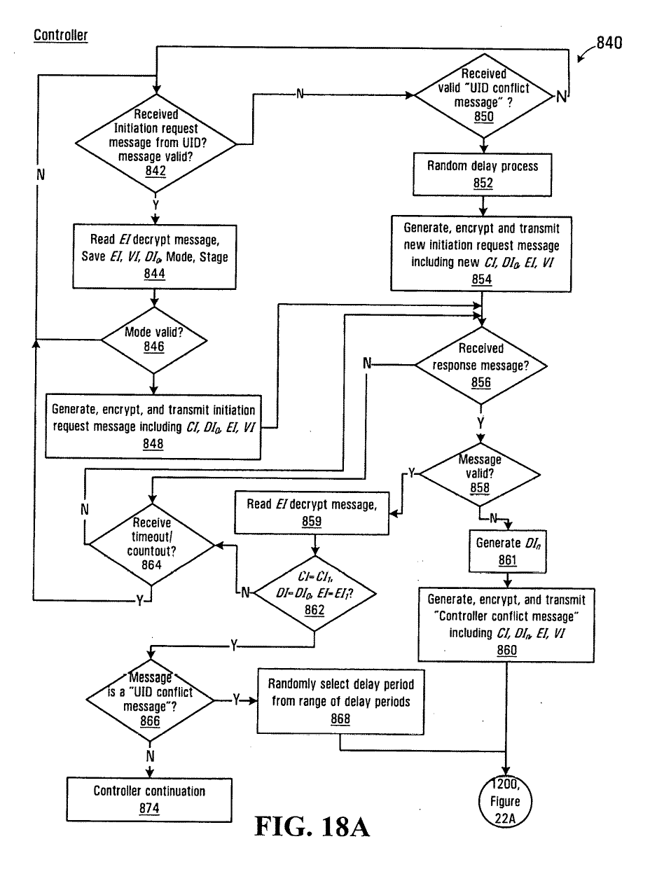

Referring to FIG. 12, in another embodiment the transmitter 482 of the transceiver 480 may be implemented using a radio frequency (RF) data transmitter 520 for transmitting RF encoded data signals. The transmitter 520 includes an antenna 522 having a transmission radiation pattern 524. The receiver 484 of the transceiver 480 may similarly be implemented using a radio frequency (RF) data receiver 526 for receiving RF encoded data signals. The receiver 526 includes an antenna 528 having a receiving range indicated by the broken line 530. In one embodiment, the transmitter 520 and receiver 526 may be configured for near-field operation where the transmission radiation pattern 524 and receiving range 530 are configured to facilitate communication when the transmitter and receiver are sufficiently close together (for example a few inches). The constrained transmission and receiving ranges 524 and 530 also provide an additional measure of security for establishing the dedicated communication session due to the limited range over which the communications could be received up by another receiver.

In other embodiments, the RF data transmitter 520 and RF data receiver 526 may be configured for IEEE 802.11 wireless local area network communications, Bluetooth communications, or other short-range RF data communications protocol.

Referring back to FIG. 8 and FIG. 9, in some embodiments transceiver 1 (310, 410) may be implemented as an optical data transceiver while transceiver 2 (312,412) is implemented as a short-range wireless data transceiver. In other embodiments transceiver 1 (310, 410) may be implemented as a near-field RF data transceiver while transceiver 2 (312,412) is implemented as a short-range wireless data transceiver. Various other combinations of optical data transceivers, near-field, and/or short range RF data transceivers may be implemented and there may be more then 2 transceivers. For example, in one embodiment described later herein, two or more optical data transceivers may be implemented on either the controller processor circuit 300 or the user interface device processor circuit 400. The additional optical data transceivers may be configured to cover different transmission angle ranges, for example.

### Message Format

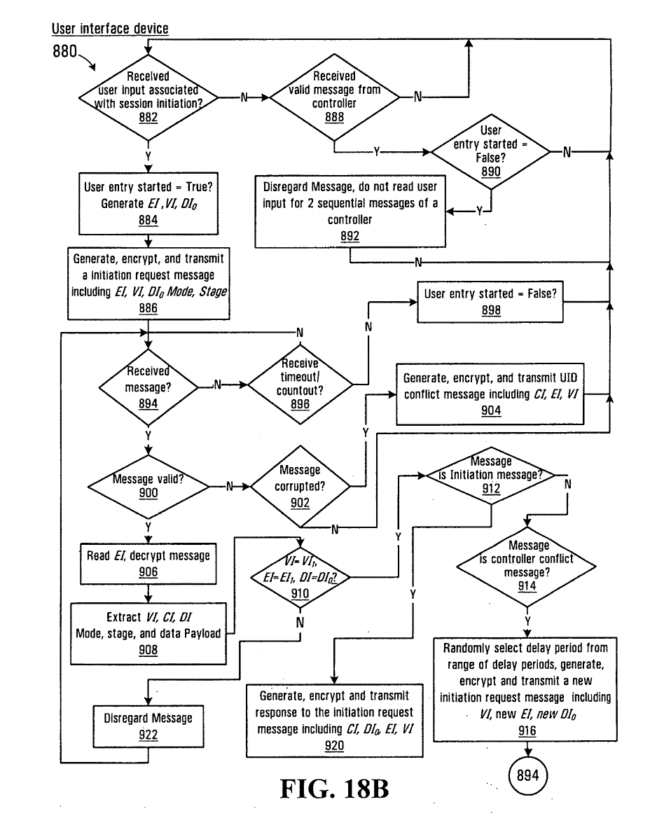

Referring to FIG. 13, an example of a message transmitted by the controller processor circuit 300 or the user interface device processor circuit 400 is shown at 580. Any of the messages 108, 114, 116, 118, 150, 152, 210-216, 160-168, 170-178, and 190-196 shown in FIG. 1-7 may be in the format of the message 580. The message 580 includes a transmission start field (TX Start) 582 which signals the start of the message. The transmission start field may be specific to the type of transceiver and may differ between the optical data transmitter 500 shown in FIG. 10 and the various RF data transmitters 520. The message 580 also includes a transmission end field (TX End) 584 that is specific to the type of transceiver and signals termination of the message.

The message 580 also includes a checksum field 586, which may include 2 bytes of data for a message having a total length of about 56 bytes excluding the transmission start field 582 and transmission end field 584. The checksum may be computed for all of or a field of the data in the message between the transmission start field 582 and transmission end field 584 in accordance with a checksum function and has the purpose of detecting any errors that may have been introduced during transmission or receipt of the message 580. For example, when the message is received, the checksum is computed using the same checksum function and compared to the checksum in the checksum field 586. If the checksum values do not correspond, the message may be processed accordingly.

In embodiments where the message 580 is encrypted, the message also includes an encryption identifier field 588. As disclosed above in connection with FIG. 4, the encryption identifier is used to identify one of a plurality of pre-defined encryption functions used by the encryption engine 204 to encrypt the message 210. For example, there may be 256 encryption functions, which would require a single byte (8-bits) of data for the encryption identifier field 588 in the message 580.

The message 580 further includes a transmitted data field 590. In embodiments where the message 580 is encrypted, the transmitted data field 590 would be the encrypted portion of the message. The checksum field 586 and encryption identifier field 588 would be transmitted in unencrypted format to permit these values to be extracted before the message 580 is decrypted. In one embodiment the transmitted data field 590 may have a length of 53 bytes, for example.

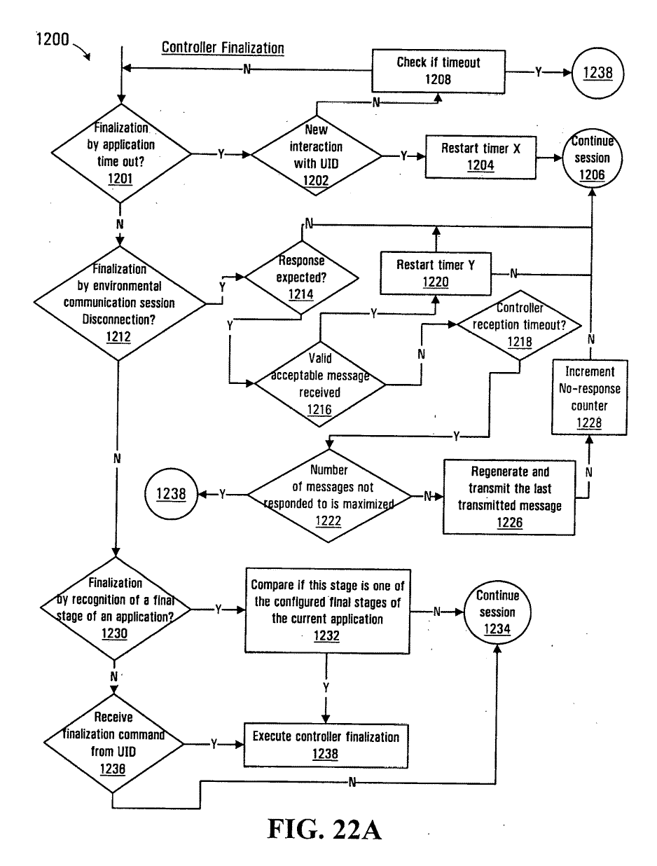

The transmitted data field 590 is shown in further detail at 590. In this embodiment the transmitted data field 590 includes a mode code field 592, which identifies the types of communication session being established. A list of exemplary communication session types along with the respective mode codes is shown in Table 2 of FIG. 20A and FIG. 20B.

The transmitted data field 590 also includes a stage code field 594, which identifies a stage of progression of the communication session and also the state of progression of operation through the communication session. The value of the stage code field 594 may be updated sequentially by the controller and/or the user interface device as the communication progresses. For example, with respect to FIG. 1, the stage code field 594 may include a single word set to “0x0001” for the messages 108, and “0x0002” for the message 114 and successively incremented thereafter. As an example for the embodiment shown in FIG. 4, the stage field 594 may include a single word set to “0x0000” for the messages 162, and “0x0001” for the message 160, and “0x0002” for the message 164, and successively incremented thereafter. For any selected mode of operation (i.e. mode code), the specific stage code may identify a message as being associated with a particular request or response.

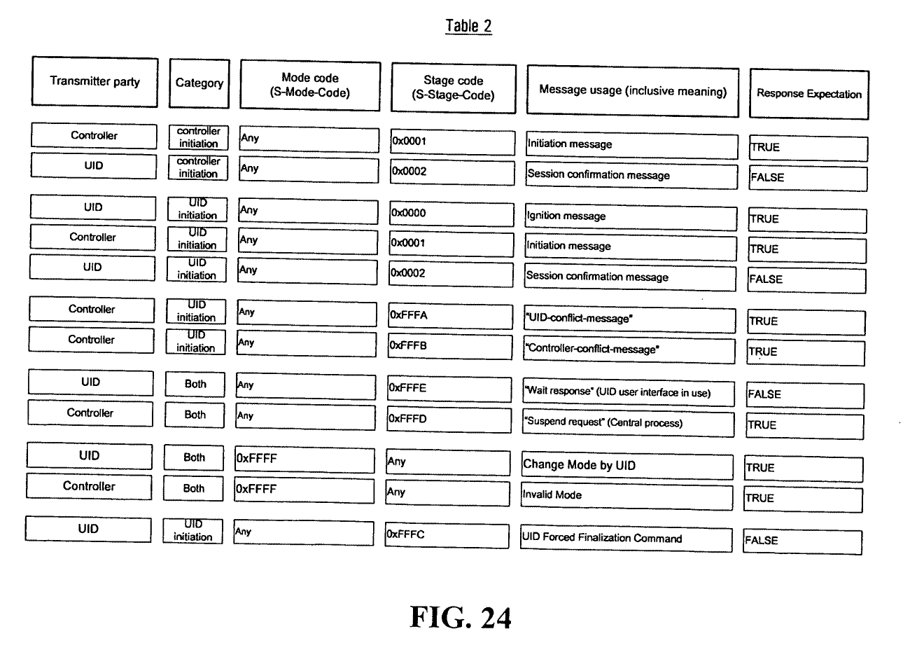

A depiction showing various messages and the applicable mode and stage codes is shown in Table 2 of FIG. 24. Generally, messages generated and transmitted by the controller are response expected messages, which means that the controller is expecting the user interface device to respond and will monitor timeout and/or countout conditions for such messages (described later herein). Generally messages generated and transmitted by the user interface device are not response expected messages.

In some cases a communication session may be established between a first user interface device and a second user interface device. In order to prevent usage and conflict, the first user interface device may start a communication session (in controller initiation mode) and messages transmitted by the second user interface device should include different identifiers. In one embodiment this may be implemented by assigning stage codes for user interface device messages as even numbered codes and stage codes of the controllers as odd numbered codes.

Referring back to FIG. 13, the transmitted data field 590 further includes a communication identifier field 596. For example, where the communication identifier is a time-based identifier, the communication identifier may be represented in 7 bytes of time data as follows:
Byte 1: 1/100 one hundreds of a second
Byte 2: second
Byte 3: minute
Byte 4: hour
Byte 5: day
Byte 6: month
Byte 7: year (2 digits)

The transmitted data field 590 also includes a dynamic identifier field 598. For the example where the dynamic identifier is also a time-based identifier, the dynamic identifier may be represented in 7 bytes of time data as set forth above or may omit the date portion, which would require only 4 bytes of data in the dynamic identifier field 598.

The transmitted data field 590 also includes a verification identifier field 599. verification identifier may be represented in 7 bytes of time data as set forth above.

The transmitted data field 590 further includes a data payload field 600. The data payload may be used to convey requests and responses details and their respective data transmitted between the controller and the user interface device associated with a communication session interaction. For example, when the controller transmits a request for user access information by transmitting a specific stage code, additional details such as type of access information requested (e.g. a memorized access card data or pin code) and/or the access control systems identification number will be transmitted in the data payload 600 of the message. The user interface device may respond by providing a specific stage code as the common identifier for the response and the additional details for the response such as the type of access information (e.g. name of the user), requested pin code, or the requested access card data will be transmitted in the data payload 600 of a message sent to the controller.

### Controller Initiated Communication Session

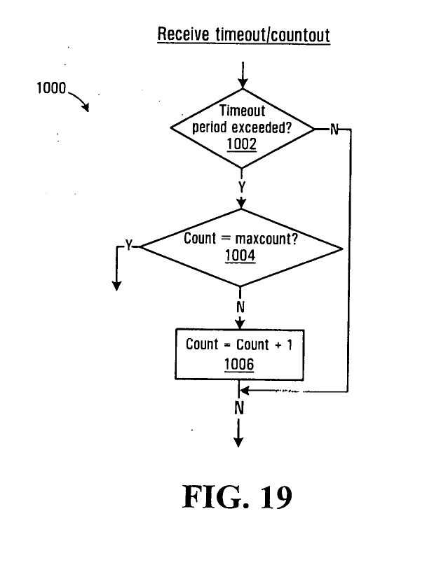

A flowchart depicting blocks of code for directing the controller processor circuit 300 to initiate a communication session with the user interface device 672 is shown at 700 in FIG. 14A. A flowchart depicting blocks of code for directing the user interface device 672 to interact with the controller processor circuit 300 is shown at 730 in FIG. 14B. The blocks generally represent codes that may be read from program memories 320 of the controller processor circuit 300 and the program memory 420 of the user interface device processor circuit, for directing the microprocessors to perform various functions related to accessing the restricted parking area 654. The actual code to implement each block may be written in any suitable program language, such as C, C++ and/or assembly code, for example.

Referring to FIG. 14A, the controller process 700 begins at block 702, which directs the microprocessor 302 to determine whether an initiation signal has been received. If an initiation signal has been received, block 702 directs the microprocessor 302 to block 704, which directs the microprocessor 302 to generate the communication identifier CIₙ, dynamic identifier DIₙ and to cause the encryption engine 450 to select the encryption function identified by the encryption identifier EIₙ.

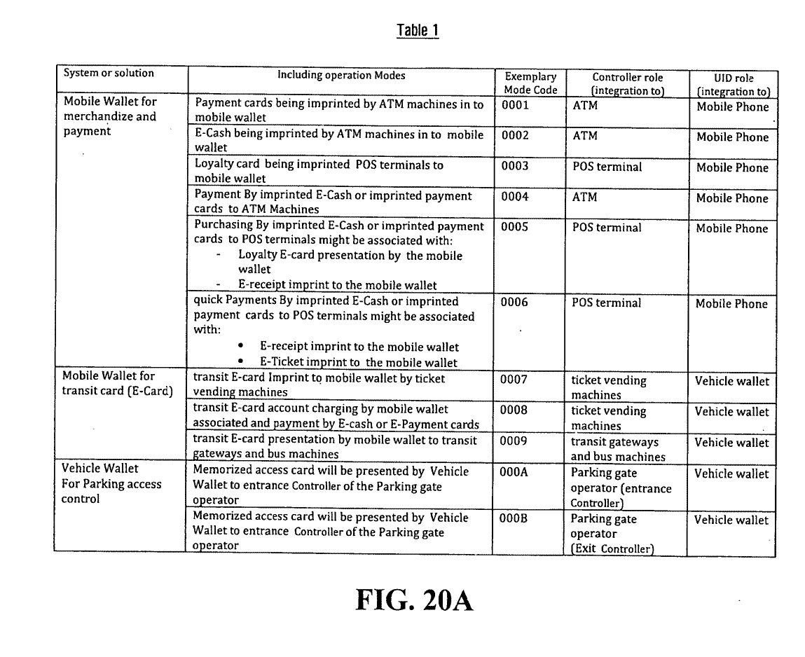

Block 706 then directs the microprocessor 302 to generate an initiation message in accordance with the message format 580 shown in FIG. 13. In the initiation message, the mode field 592 of the transmitted data field 590 is set to a value identifying the message as an initiation message and the stage field 594 may be set to “0x0001” since this is a first message in the communication. The stage code field 592 of the transmitted data field 590 may be set to “0x0001” since this is a first message in the communication as an initiation message and the mode code field 594 may be set to “0x000A” as the identifier of parking access control system listed in FIG. 15.

The initiation message also includes the generated CIₙ value in the field 596 and the generated DIₙ value in the field 598 of the transmitted data field 590. The data payload field 600 may be left empty for the initiation message. Block 706 then directs the microprocessor 302 to cause the encryption engine 450 to encrypt the generated data field 590 using the encryption identifier EIₙ selected at block 704. The selected encryption identifier EIₙ is also included in the encryption identifier field 588 as an unencrypted value. Block 706 further directs the microprocessor 302 to compute a checksum for the message, which is included in the checksum field 586. Block 706 then directs the microprocessor 302 to cause the initiation message to be transmitted by the first transceiver 310.

Referring to FIG. 14B, the user interface device process 730 begins at block 732, which directs the microprocessor 402 to determine whether an initiation message has been received. If a message has not yet been received the block 732 is repeated. For example, block 732 may cause the microprocessor 402 to periodically check for a received initiation message or the receiver may be configured to generate an interrupt when a message is available. If a message has been received block 732 further directs the microprocessor 402 to determine whether the message is valid, which may involve determining whether both a TX start and TX end have been received and computing a checksum for the received message. The computed checksum is compared with the received checksum in the checksum field 586 of the message, and a match indicates that the message has not been corrupted.

The user interface device process 730 then continues at block 734, which directs the microprocessor 402 to read the encryption identifier EIₙ in the encryption identifier field 588 and to use the encryption function defined by EIₙ to decrypt the transmitted data in the field 590. Block 736 then directs the microprocessor 402 to process the decrypted data and to extract data from the mode code field 592, stage code field 594, communication identifier field 596, and dynamic identifier field 598, and the data payload field 600 and to save the contents of the fields in the locations 442, 444, and 446 of the variable memory 440.

Block 738 then directs the microprocessor 402 to generate a verification identifier VI, which may involve reading a previously used communication identifier from the first location 442 of the variable memory 440, for example. Block 740 then directs the microprocessor 402 to generate a response message. The response message may be generated generally as described above in connection with block 706 of the controller process 700, except that current values for CIₙ, DIₙ, and EIₙ are read from the first location 442 and included in the response message, the stage code is incremented to “0x0002”, and the verification identifier VI is included in the field 599. In this embodiment, the mode code in the message received from the controller processor circuit 300 identifies the message as an initiation message. Block 740 also directs the microprocessor 402 to encrypt the message using the same encryption function identified by the encryption identifier EIₙ that was received from the controller processor circuit 400, and to cause the first transceiver 410 to transmit the message.

Referring back to FIG. 15A, the controller process 700 then continues at block 808, which directs the microprocessor 302 to determine whether a message has been received in response to the initiation message from a user interface device, such as the user interface device 672 shown in FIG. 15. If a message has been received block 708 further directs the microprocessor 302 to determine whether the message is valid. In addition to checking for the TX start and TX end and computing and comparing the checksum values as described above in connection with block 732, block 708 also directs the microprocessor 302 to read the value of the encryption identifier EIₙ from the field 588 and to compare the value with the current value of EIₙ in the first location 342 of variable memory 340. If the values of EIₙ do not match, then the response was not received in response to the initiation message transmitted at block 706, and the received message is disregarded. Advantageously, block 708 thus provides an early indication that the message should not be associated with a communication session identified by the communication identifier CIₙ that had been transmitted.

The controller process 700 then continues at block 710, which directs the microprocessor 302 to decrypt the message. Block 712 then directs the microprocessor 302 to process the message to extract data from the mode code field 592, stage code field 594, communication identifier field 596, dynamic identifier field 598, and the verification identifier field 599. Block 712 also directs the microprocessor 302 to save the contents of these fields in the locations 342, 344, and 346 of the variable memory 340.

Block 714 then directs the microprocessor 302 to determine whether the communication identifier CI in the received message corresponds to the current communication session communication identifier CIₙ, and whether the dynamic identifier DI in the received message corresponds to the current dynamic identifier DIₙ (i.e. the message is “acceptable”). If these identifiers do not correspond, then the message is not associated with the current communication session and, block 714 directs the microprocessor 302 back to block 704, where a new communication identifier CIₙ and DIₙ are generated, and a new encryption identifier EIₙ is selected for transmission of a further initiation message. If at block 714, the identifiers correspond, then the message is associated with the current communication session and, the process continues at block 750 of FIG. 15A.

### Access Control System Example

Referring to FIG. 15, in accordance with one embodiment the controller processor circuit 400 shown in FIG. 8 may be implemented in an access control system shown generally at 650. The access control system 650 is configured to interact with a vehicle 652 that is attempting to gain access to a restricted parking area 654. The parking area 654 has a gate 656 which may be opened and closed by a gate actuator 658. The gate actuator 658 includes an input 660 for receiving an actuator signal from the output 307 of the controller actuator interface 305 (shown in FIG. 8). In this embodiment the parking area 654 also has a barrier actuator 662 that raises or lowers a barrier 666 in response to receiving an actuator signal from the output 307 of the controller actuator interface 305 at the input 664. When the barrier 666 is in a raised position (shown in broken outline at 668), progress of a second vehicle 670 that is attempting to gain access to a restricted parking area 654 is impeded. The vehicles 652 and 670 each have respective user interface devices 672 and 674 that may be implemented using the user interface device processor circuit 400 shown in FIG. 9. In this embodiment the user interface devices 672 and 674 are disposed on the vehicles 652 and 674 to enable a line of sight communication with the first and second transceivers 310 and 314 of the controller processor circuit 300.

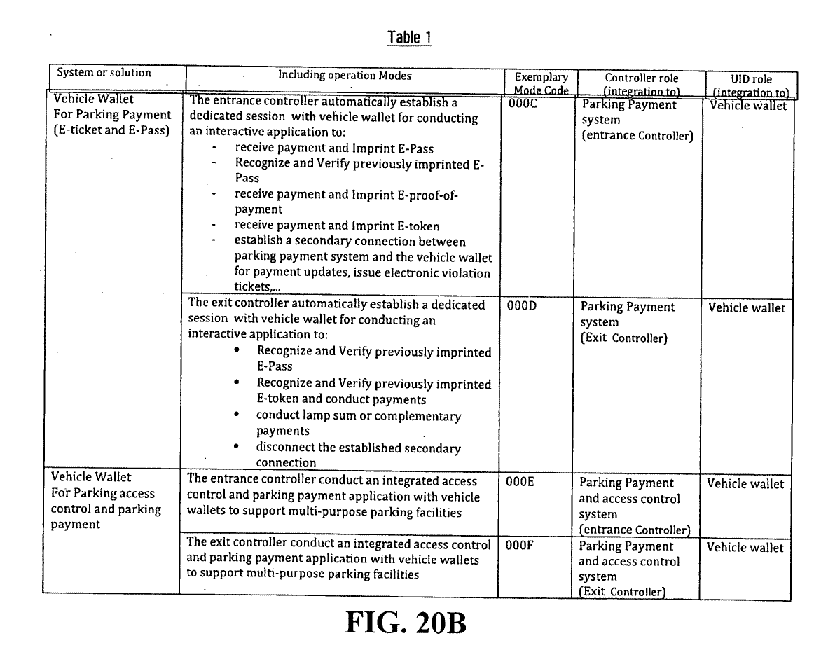

Referring to FIG. 16A, a flowchart depicting blocks of code for directing the controller processor circuit 300 to interact with a user interface device in a parking access control application, is shown at 750 in FIG. 16A. It is assumed that the process 700 and 730 shown in FIG. 14A and FIG. 14B has been completed and that a communication session is established between the processor circuit 300 and the user interface device 672.

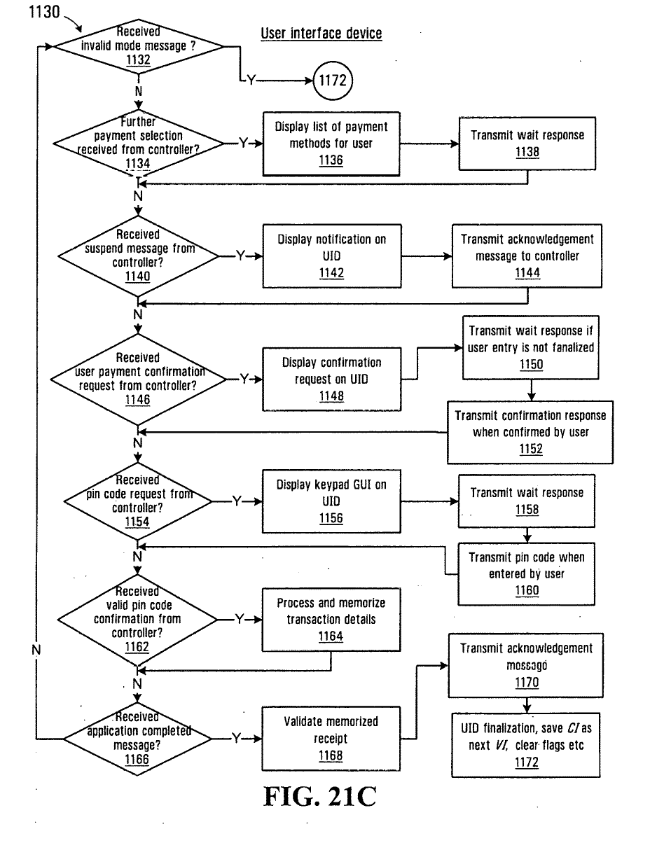

The process 750 begins at block 1400, which directs the microprocessor 302 to generate a request for access information, which includes the communication identifier CIₙ, dynamic identifier DIₙ, encryption identifier EIₙ, verification identifier VI, mode, stage, and data payload. In embodiments where the barrier actuator 662 is implemented, block 1402 directs the microprocessor 302 to cause an activation signal to be generated by the actuator interface 305 of the I/O 304 for raising the barrier 666 to the position 668. The barrier prevents the second vehicle 670 from entering a region between the barrier 666 and the gate 656 while a dedicated communication session between the controller processor circuit 300 and the user interface device 672 of the vehicle 652 is in progress. The process then continues at block 1404, which directs the microprocessor 302 to determine whether a valid and acceptable response has been received from the user interface device, in which case the microprocessor is directed to block 1406. If at block 1404, the message is not valid or not acceptable (i.e. the identifiers do not correspond), then the microprocessor 302 is directed to execute a timeout/countout process as described later herein in connection with FIG. 19.

If at block 1406, the message received form the user interface device is a wait response, the microprocessor is directed back to block 1400. If the message received form the user interface device is not a wait response, the microprocessor is directed to block 1408, where the message is processed to extract the access information. Block 752 then directs the microprocessor 302 to read the access information and to cause the network interface 316 to transmit the user interface device access information to the host system for authorization. The host system may be an access control server that includes information for identifying whether the provided access information is associated with a vehicle 652 that is authorized to access the restricted parking area 654. In other embodiments, the information for authorizing access may be held locally on the processor circuit 300.

The process 750 then continues at block 754, which directs the microprocessor 302 to generate a new dynamic identifier DIₙ and to select a new encryption identifier EIₙ. Block 756 then directs the microprocessor 302 to generate a suspend message including the communication identifier CIₙ, new dynamic identifier DIₙ, and new encryption identifier EIₙ, and verification identifier VI. Block 756 also directs the microprocessor 302 to set the mode code to a value corresponding to a “suspend” condition, while the controller processor circuit 300 is waiting for a response from the host system. The stage code would also be updated to “0X0003”. Block 756 then directs the microprocessor 302 to encrypt and transmit the suspend message.

The controller process 750 then continues at block 758, which directs the microprocessor 302 to determine whether a response has been received from the host system. If a response has been received, the process continues at block 762 on FIG. 16C. If at block 758 a response has not been received, the process continues at block 760, which directs the microprocessor 302 to determine whether a response to the suspend message transmitted to the user interface device 672 has been received. If a response has not been received within a timeout period then block 760 directs the microprocessor 302 back to block 702 of FIG. 15A. If at block 760, a response has been received then block 760 directs the microprocessor 302 back to block 754 and blocks 754 to 758 are repeated.

A flowchart depicting blocks of code for directing the user interface device 672 to interact with the controller processor circuit 300 in a parking access interaction is shown at 781 in FIG. 16B. Referring to FIG. 16B, the user interface device process 781 starts at block 782, when a message is received from the controller processor circuit 300. Blocks 782, 784 and 786 direct the microprocessor 402 to receive, validate, decrypt, and process the suspend message generally as described above in connection with FIG. 14B. Block 788 then directs the microprocessor 402 to determine whether the communication identifier CI in the received message corresponds to the current communication session communication identifier CIₙ, whether the dynamic identifier DI in the received message corresponds to the current dynamic identifier DIₙ, and whether the verification identifier VII in the received message corresponds to the current verification identifier VI. If these identifiers do not correspond, then the message is not associated with the current communication session and, block 786 directs the microprocessor 402 to disregard the message. If at block 786, the identifiers correspond, then the message is associated with the current communication session and, the process continues at block 790, which directs the microprocessor 402 to determine from the received mode code whether the message is a suspend message. If the message is not a suspend message then block 796 directs the microprocessor 402 to generate a response message for transmission back to the controller processor circuit 302. The response message is generated to fulfill the function of informing the controller processor circuit 302 that the user interface device 672 is still participating in the communication session.

If at block 790, the message is a suspend message then block 790 directs the microprocessor 402 to block 792. Block 792 directs the microprocessor 402 to provide operator feedback informing an operator of the vehicle 652 of the suspend condition while awaiting a response from the host system. Block 794 directs the microprocessor 402 to encrypt and transmit the message generated at either block 792 or block 796, whichever is applicable. Referring back to FIG. 16A, the response from the user interface device 672 is processed in accordance with block 760, as described above.

Referring to FIG. 16C, the controller process 750 continues at block 762 when an access response has been received from the host system at block 758 of FIG. 16A. Block 762 directs the microprocessor 302 to generate a new dynamic identifier DIₙ and to select a new encryption identifier EIₙ. Block 764 then directs the microprocessor 302 to generate, encrypt and transmit an authorization message based on the access response from the host system. The access response may be in the form of an authorization for the vehicle 652 to enter the restricted parking area 654 or in the form of an access denial and the authorization message may include either an authorization or a denial in the data payload field 600.

Referring to FIG. 16D, the process 781 continues at block 792, which directs the microprocessor 402 to determine whether a message has been received by the user interface device 672, and if so to read the encryption identifier EIₙ and determine whether the message is valid. When a valid message is received, block 792 directs the microprocessor 402 to block 794, which directs the microprocessor 402 to decrypt the message using the encryption function corresponding to the identifier EIₙ. Block 796 then directs the microprocessor 402 to process the message and extract the various identifiers, mode code, stage code and the authorization information in the data payload field 600. Block 798 directs the microprocessor 402 to determine whether the communication identifier matches the currently saved communication identifier CIₙ, whether the dynamic identifier matches the currently saved dynamic identifier DIₙ, and whether the verification identifier V/I is correct. If the identifier match then the message is verified as being associated with the current communication session and block 798 directs the microprocessor 402 to block 800, which directs the microprocessor 402 to provide user feedback to an operator of the vehicle 652. For example, a display associated with the user interface device 672 may display the authorization information for indicating to the operator whether access has been authorized or denied. Block 802 then directs the microprocessor 802 to generate, encrypt and transmit a response message back to the controller processor circuit 300. Since at this time, the communication session is in an initiation phase, it is preferable to not exchange any critical information such as payment or access information. Once the communication session is established in accordance with the described embodiments, the security of further messages transmitted is enhanced.

Referring back to FIG. 16C, if at block 766, a response has been received from the user interface device 672, the process continues at block 768. Block 768 directs the microprocessor 302 to determine whether the access response from the host received at block 758 (FIG. 16A) was an authorization to enter the restricted parking area 654, in which case block 770 then directs the microprocessor 302 to cause the actuator interface 305 generate an activation signal for opening the gate 656. The process then continues at block 762 and a further copy of the authorization message is transmitted.

If at block 768 it is determined that access to the restricted parking area 654 is denied, the gate 656 is not opened and the process continues at block 762 and a further copy of the authorization message is transmitted. The controller processor circuit 300 thus continues to interact with the user interface device 672 to keep the communication session open. Advantageously, this facilitates determination by the controller processor circuit 300 whether the user interface device 672 of the vehicle 652 is still in range of the first transceiver 310.

If at block 766 no response is received from the user interface device 672, the process continues at block 772, which directs the microprocessor 302 to determine whether a timeout value has been reached. The timeout value may be defined as a time period within which the controller processor circuit 300 expects to receive a response from the user interface device 672. If at block 772, the timeout period has not yet been reached, block 772 directs the microprocessor 302 to block 774. Block 774 directs the microprocessor 302 to determine whether a message count-out number has been reached. The count-out number may be a limitation on the number of times the controller processor circuit 300 will transmit the authorization message at block 764. If at block 774, the message count-out number has not yet been reached, block 774 directs the microprocessor 302 back to block 762 and a further copy of the authorization message is transmitted.

If no message is received by the controller processor circuit 300 within a defined time period, or the message count-out number has been reached, either of blocks 772 or 774 directs the microprocessor 302 to block 776. Block 776 directs the microprocessor 302 to determine whether the gate 656 is open based on the state of the activation signal at the actuator interface 305. If the gate 656 is open, block 776 directs the microprocessor 302 to block 778, which directs the microprocessor 302 to cause the actuator interface 305 to generate an activation signal for closing the gate 656. Block 780 then directs the microprocessor 302 to generate an activation signal for lowering the barrier 666 to permit the second vehicle 670 to pass into range of the proximity detector 138 and the first transceiver 310. Block 780 also directs the microprocessor 302 back to block 702, where a new communication session may be established between the controller processor circuit 300 and the user interface device 674 of the vehicle 670.

### User Interface Device Initiated Communication

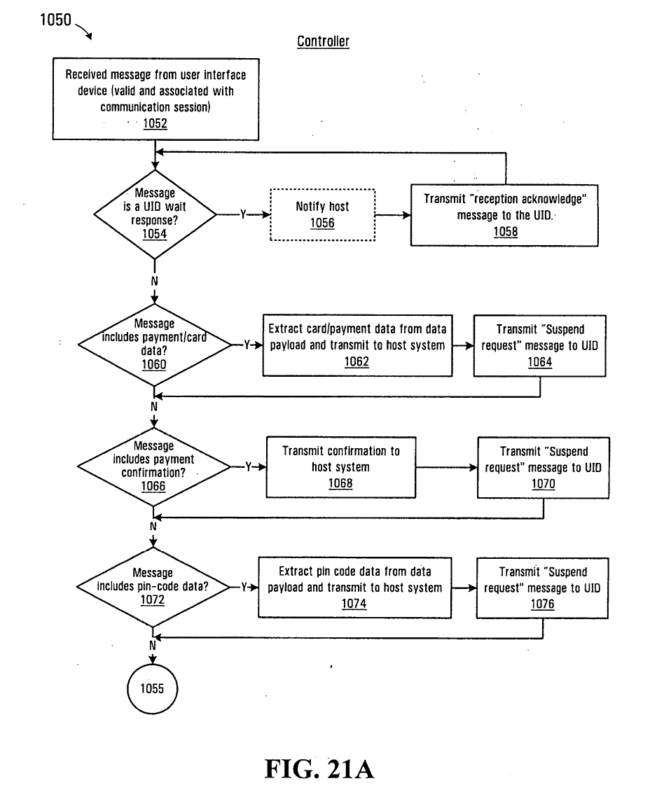

Referring to FIG. 17, in one embodiment the user interface device may be implemented on a mobile device, such as the mobile phones 820 and 822 which each include a respective user interface device 824 and 826. The user interface devices 824 and 826 may be implemented using the processor circuit 400, or the user interface device functions may be implemented using a processor circuit of the mobile phones 820 and 822. When the mobile phones 820 and 822 simultaneously attempt to initiate a communication session with the controller processor circuit 300, conflicts and interference may result and the processor circuit 300 may be required to resolve these potential conflicts.

As shown in FIG. 8, the controller processor circuit 300 is in communication with the host system 317. In many embodiments the host system 317 comprises a remote server that provided verification services to the controller processor circuit 300. However, in some embodiments the host system 317 may be co-located with, or part of, the controller processor circuit 300.

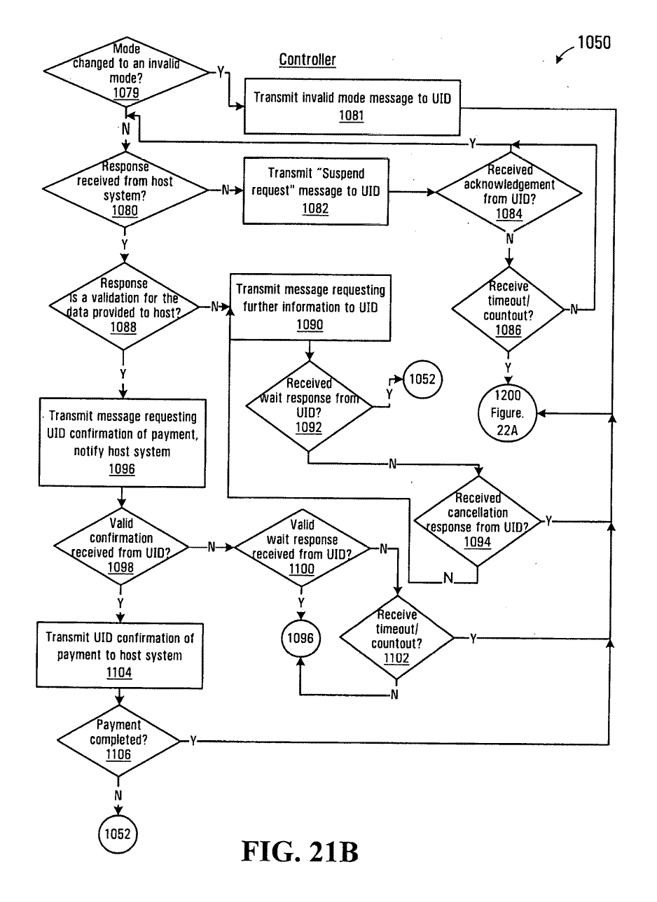

Referring to FIG. 18A, a flowchart depicting blocks of code for directing the controller processor circuit 300 to respond to the initiation signals generated by the user interface devices 824 and 826 is shown at 840. The process 840 begins at block 842, which directs the microprocessor 302 of the processor circuit 300 to determine whether a user interface device initiation message has been received and whether the message is a valid message. For example, a message that is missing a Tx End (584 in FIG. 13) would not be a valid message. Block 844 then directs the microprocessor 302 to read the encryption identifier EI in the received message, and to decrypt the message using the encryption function identified by the encryption identifier EI. The decrypted message includes a mode code corresponding to one of the operation modes listed in Table 1 shown in FIG. 20 and FIG. 20A. For example, the controller 300 may be implemented as a transit ticket vending machine, and the mode code may be “0007” indicating this mode of operation. The message also includes a stage code, which in this case may be “0001” indicating that the message is a communication initiation message. The message also includes a verification identifier VI as described above in connection with FIG. 5 and a dynamic identifier DI₀ generated by the user interface device.

Block 846 then directs the microprocessor 302 to determine whether the mode code corresponds to a valid operating mode. If not a valid operating mode, block 846 directs the microprocessor 302 back to block 842. If the mode code is valid, block 846 directs the microprocessor 302 to block 848, which directs the microprocessor to generate a controller initiation message. The controller initiation message includes a communication identifier CI and further includes the same encryption identifier EI, dynamic identifier DI₀, and verification identifier VI received in the user interface device initiation message at block 842.

If at block 842, the user interface device initiation message is not a valid message, then the microprocessor 302 is directed to block 850. Block 850 directs the microprocessor 302 to determine whether a valid user interface device conflict message has been received. The user interface device conflict message is generated and transmitted by one of the user interface devices 824 or 826 as described below. If a valid user interface device conflict message has not been received, block 850 directs the microprocessor 302 back to block 842.

If a valid user interface device conflict message has been received, block 850 directs the microprocessor 302 to block 852, which directs the microprocessor to select a delay period randomly selected from a range of delays. When the delay has expired, block 852 directs the microprocessor 302 to block 854. Block 854 then directs the microprocessor 302 to generate a new initiation message with a new communication identifier CI, dynamic identifier DI₀, and the verification identifier EI received in the user interface device initiation message at block 842. Block 854 also directs the microprocessor 302 to encrypt the message using the encryption function identified by the encryption identifier EI received in the message at block 842. The process of blocks 850 to 854 is executed when more then one user interface device has attempted to establish a communication session with the controller and results in a further initiation message being sent to the user interface device that transmitted the user interface device initiation message received at block 842 after a delay randomly selected from a range of delays. The random delay is selected from a range of delay periods that are selected to provide sufficient delay to allow one of the user interface devices 824 or 826 to successfully transmit a message to the controller without interference potentially resulting in corruption.

Block 856 then directs the microprocessor 302 to determine whether a response message has been received from one of the user interface devices 824 or 826. If no response message has been received, block 856 directs the microprocessor 301 to block 864, which directs the microprocessor 302 to determine whether there has been a receive timeout or countout. Referring to FIG. 19, the receive timeout/countout process is shown at 1000. The process begins at block 1002, which directs the microprocessor the microprocessor 302 to determine whether a timeout period associate with receiving a message has been exceeded. If the timeout period is not exceeded at block 1002, the process 1000 ends with a result of no (i.e. “N”). If the timeout period is exceeded at block 1002, the process 1000 continues at block 1004 which directs the microprocessor 302 to determine whether the number of timeouts exceeded is equal to a maxcount value, in which case the process ends with a result of yes (i.e. “Y”). If at block 1004, the number of timeouts exceeded is still less than the maxcount value, then block 1006 increments the count and the, the process 1000 ends with a result of no (i.e. “N”). The process 1000 thus determines whether response criteria have been met.

Referring back to FIG. 18A, if at block 864 there has not been a receive timeout or countout, then the microprocessor 302 is directed back to block 856. If at block 864 there has been a receive timeout or countout, then the microprocessor 302 is directed back to block 842. When at block 856, a message has been received, the microprocessor 302 is directed to block 858, which directs the microprocessor to determine whether the message is a valid message, as disclosed earlier herein. If the message is valid, then block 858 directs the microprocessor 302 to block 859, where the message is decrypted using the encryption function identified by the encryption identifier EI. The process 840 then continues at block 862, which directs the microprocessor 302 to compare the communication identifiers, dynamic identifiers, and encryption identifiers with identifiers set in block 848. If the identifiers do not match then, block 862 directs the microprocessor 302 to block 864 to determine whether there has been a receive timeout or countout. If at block 862 the identifiers do not match then, block 862 directs the microprocessor 302 to block 866, where the microprocessor is directed to determine whether the message is a user interface device conflict message indicating that one of the user interface devices 824 or 826 has detected a conflict. If at block 866, the message is not a conflict message then the process 840 continues with the communication session at block 874.

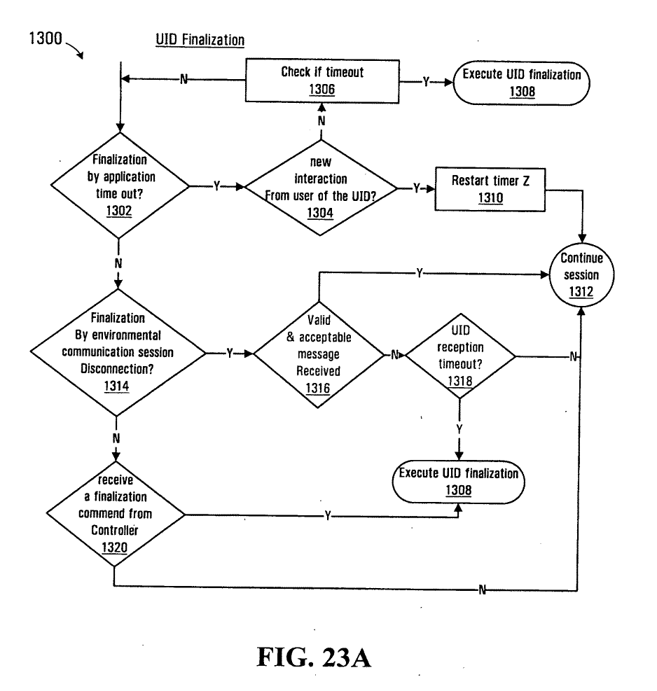

If at block 866, if the message is a conflict message than the process 840 continues at block 868, which directs the microprocessor 302 to randomly select a delay period. After the delay period has expired the process continues with a controller finalization process at block 1200 of FIG. 22A. In the controller finalization process, the all applicable counters and flags are reset to initial values and the controller is placed in a state were it is ready to establish a new communication session, either initiated by the controller as shown in FIG. 14 or initiated by the user interface device in FIG. 18.

If at block 858, the message is not valid the microprocessor 302 is directed to block 861, which directs the microprocessor 302 to generate a new dynamic identifier DIₙ. Block 860 then directs the microprocessor 302 to generate a controller conflict message including the communication identifier CIₙ, the dynamic identifier DIₙ, and the verification identifier received at block 842. The message is encrypted using an encryption function identified by a newly selected encryption identifier EI and transmitted. The process continues with a controller finalization process at block 1200 of FIG. 22A.

Referring to FIG. 18B, a flowchart depicting blocks of code for directing either of the user interface devices 824 or 826 to respond to the initiation message generated by the controller processor circuit 300 is shown at 880. The user interface devices 824 and 826 may be implemented using the processor circuit 400 shown in FIG. 9. The process begins at block 882, which directs the microprocessor 402 to determine whether user input has been received at the associated mobile phone 820 or 822 that is indicates that an initiation signal in the form of an initiation message should be sent. For example, the user may press a key or provide other user input indicating that a payment should be made using a credit card. If user input is received, block 884 directs the microprocessor 402 to set a Boolean flag indicating that user entry has been started and to select an encryption identifier EI, a verification identifier VI, and to generate a dynamic identifier DI₀. Block 886 then directs the microprocessor 402 to generate a user interface device initiating message including the encryption identifier EI, verification identifier VI, dynamic identifier DI₀, a mode code corresponding to a mode of operation from Table 1 (FIG. 20), and a stage code (in this case “0001” as disclosed above). Block 886 also directs the microprocessor 402 to encrypt the message using the encryption function identified by the encryption identifier EI, and transmit the message.

If at block 882, user input is not received, the microprocessor 402 is directed to block 888. Block 888 directs the microprocessor 402 to determine whether a valid message has been received from the controller processor circuit 300, in which case if at block 890 the Boolean flag indicates that user entry has not been started the microprocessor is directed to block 892, which directs the microprocessor to ignore user input for the next two messages received from the controller. Block 892 also directs the microprocessor 402 back to block 882. If at block 890, the Boolean flag indicates that user entry has been started, the microprocessor is directed to block 882. If at block 888, a valid message has not been received from the controller processor circuit 300, the microprocessor 402 is directed back to block 882.

The user interface device initiation message sent at block 886 is handled by the controller processor circuit 300 as described above and results in an initiation message of a controller conflict message being transmitted by the controller. At block 894, if a message is not received, the microprocessor 402 is directed to block 896 where the receive timeout/countout process shown in FIG. 19 is performed with execution returning to block 894 if the timeout/countout criteria are not met. If the timeout/countout criteria are met at block 896, then block 898 directs the microprocessor 402 to set the Boolean flag indicating that user entry has been started to False, and the microprocessor is directed back to block 882. Block 894 and 896 thus determine whether a controller initiation message is received from the controller within a pre-determined time, and if not the user would have to provide further user input at block 882 in an attempt to initiate the communication.

The process 880 then continues at block 900, which directs the microprocessor 402 to determine whether the message is valid as described earlier herein. If the message is valid, then block 900 directs the microprocessor 402 to block 906, which directs the microprocessor to read the encryption identifier and to decrypt the message. Block 908 directs the microprocessor to extract the verification identifier VI, mode code, stage code, communication identifier CI and dynamic identifier DI and data payload. Block 910 then directs the microprocessor 402 to determine whether the verification identifier, dynamic identifier, and encryption identifiers in the message match the identifiers in the user interface device initiation message generated at block 886. If the identifiers match then the process continues at block 912, which directs the microprocessor 402 to determine whether the message is an initiation message. If the message is an initiation message, then the process continues at block 920, which directs the microprocessor 402 to generate a response to the controller initiation message that includes the communication identifier CI and dynamic identifier DI₀, mode code, stage code, and optionally the verification identifier VI. In other embodiments, once the verification identifier transmitted in the user interface device initiation message at block 888 is verified at block 910, use of this identifier in further message is discontinued. Block 920 directs the microprocessor to encrypt the response message using the encryption function identified by the encryption identifier EI received from the controller at block 906.

If at block 900, the message is not valid, block 902 directs the microprocessor 402 to determine whether the message is corrupted. If at block 902, the message is corrupted, block 904 directs the microprocessor 402 to generate a user interface device conflict message including the communication identifier CI, dynamic identifier DI the verification identifier VI. Block 904 also directs the microprocessor 402 back to block 882. If at block 902, the message is not corrupted the microprocessor 402 is directed back to block 882. Execution of block 902 thus facilitates a determination that a message has become corrupted, possibly due to interference between initiation or other messages transmitted by both the user interface device 824 and the user interface device 826 that overlap in time.

If at block 910, the verification identifier and encryption identifiers in the message do not match the identifiers in the user interface device initiation message generated at block 886, the microprocessor 402 is directed to block 922. Block 922 directs the microprocessor 402 to disregard the message and directs the microprocessor back to block 894. Block 910 and 922 thus facilitate a determination that a message received from the controller does not include a verification identifier VI or an encryption identifier EI that corresponds to the identifiers generated at block 884 and transmitted at block 886. In this case the message is disregarded by the user interface device.

If at block 912, the message is not an initiation message, then the microprocessor 402 is directed to block 914, which directs the microprocessor to determine whether the message is a controller conflict message. If the message is a controller conflict message, then the process continues at block 916, which directs the microprocessor 302 to select a random delay period, as described above. Block 916 directs the microprocessor 402 to generate a new user interface device initiation message including the verification identifier VI and a newly selected encryption identifier EI, and a new dynamic identifier DI₀. The message is encrypted and is transmitted when the delay has expired. The random delay facilitates re-transmission of the initiation message. If for example, the user interface devices 824 and 826 were each attempting to initiate communication sessions at the same time, after the conflict message is received at each of the user interface devices different delay times would be selected and the retransmission of respective initiation messages would have higher likelihood of not interfering and resulting in further conflict.

### Payment Interaction

Once a communication session has been initiated and established in accordance with either the process shown in FIG. 14 or FIG. 18, one of a plurality of operational interactions may be accommodated as set forth in Table 1 in FIG. 20. The type of interaction is defined by the mode code that is transmitted by either the user interface device or the controller, depending on whether the communication session is controller initiated (FIG. 14) or user interface device initiated (FIG. 18).

One specific example of an interaction is a payment interaction, which may involve payment for accessing a restricted parking area 654 (FIG. 15), payment for a ticket such as a transit pass, payment for merchandise, etc. The payment may involve various card numbers that are maintained in the location 448 of the variable memory 440 of the user interface device processor circuit 400. For example, credit and bank card numbers, loyalty card numbers, and other payment data may be read or entered into the user interface device for use in payment interactions. As disclosed above the type of interaction is determined by the mode code in the initiation message, which may be set by the controller or the user interface device and may be changed during the communication session by either the user providing user input at the user interface device that results in a particular interaction mode being selected or changed from a previous interaction mode.

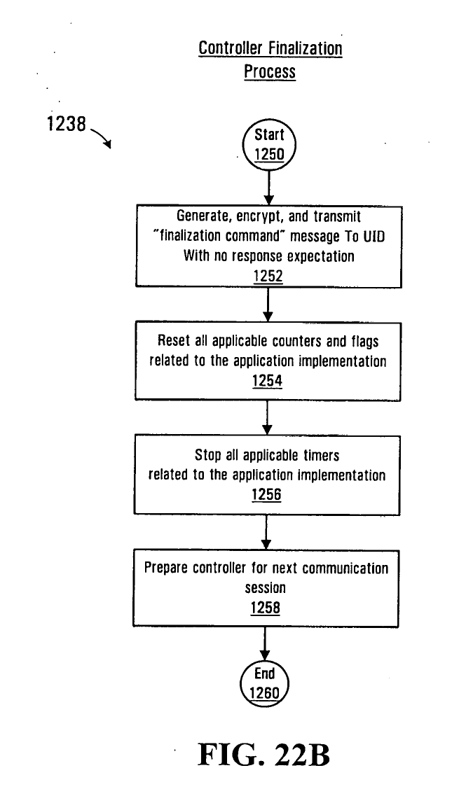

Referring to FIG. 21A, a flowchart depicting blocks of code for directing the controller processor circuit 300 to process a payment interaction by one of the user interface devices 824 and 826 is shown at 1050. The process will generally involve transmission and receipt of a number of messages between the controller 300 and the user interface device after the communication session has been established. Accordingly, the process 1050 would generally be repeated several times for different message types sent between the controller and user interface device during the interaction.

The process 1050 begins at block 1052, which directs the microprocessor 302 to receive messages from the user interface device. Block 1052 also directs the microprocessor to determine whether the messages are valid and associated with a communication session generally as described above in connection with blocks 858, 859, and 862 of the process 840 shown in FIG. 18A.

Block 1054 then directs the microprocessor 302 to determine whether the message is a user interface device wait response message. A wait response message is transmitted by the user interface device processor circuit 400 when awaiting user input from the user of the user interface device, such as for example awaiting selection of a payment card or awaiting entry of a pin code. If the message is a wait message, then block 1054 directs the microprocessor 302 to block 1056, which optionally directs the microprocessor 302 to notify the host that the controller is awaiting a response from the user interface device. Block 1058 then directs the microprocessor 302 to transmit a message acknowledging reception of the user interface device wait response. The wait response message transmission by the user interface device processor circuit 400 and the subsequent acknowledgment message transmitted by the controller processor circuit 300 maintains the communication session during the time that it takes the user to enter the required information.

If at block 1054 the message is not a wait response message, then the process 1050 continues at block 1060, which directs the microprocessor 302 to determine whether the message includes payment or card data in the data payload of the message. If the message does include card or payment data, then block 1060 directs the microprocessor to 1062, which directs the microprocessor 302 to extract the data and to transmit the data to the host system 317. In this embodiment, the host system 317 may be a payment data server that is configured to access payment information from banks, companies, and other institutions and verify that the card or payment information provided by the user interface device identifies a valid payment card or method. For example, if a credit card is identified in the data payload, the host system 317 then accesses the appropriate database of the card issuer to determine whether the card is valid. The process then continues at block 1064, which directs the microprocessor 302 transmit a suspend message to the user interface device. The suspend message informs the user interface device that the controller processor circuit 400 is processing information, and facilitates maintaining the communication session while the host system 317 is processing the card or payment information. Block 1064 then directs the microprocessor 302 to block 1066. If at block 1060 the message did not include card or payment data, the microprocessor is directed to block 1066.

Block 1066 directs the microprocessor 302 to determine whether the message includes a payment confirmation provided by the user interface device. The payment confirmation may be received after a valid card has been verified by the host system 317 and the user of the user interface device has been requested by the controller to provide confirmation of the payment using the card. When the message includes a payment confirmation, block 1066 directs the microprocessor 302 to block 1068, which directs the microprocessor to transmit the confirmation information to the host system 317. The process then continues at block 1070, which directs the microprocessor 302 transmit a suspend message to the user interface device. Block 1070 then directs the microprocessor 302 to block 1072. If at block 1066 the message did not include a payment confirmation, the microprocessor 302 is directed to block 1072.

Block 1072 directs the microprocessor 302 to determine whether the message includes pin-code data. If the message includes pin code data block 1072 directs the microprocessor 302 to block 1074, which directs the microprocessor to extract the pin-code data from the data payload and to transmit the pin code data to the host system 317. The process then continues at block 1076, which directs the microprocessor 302 transmit a suspend message to the user interface device. Block 1076 then directs the microprocessor 302 to block 1079 (FIG. 21B). If at block 1072 the message did not include a pin-code information, the microprocessor 302 is directed to block 1079 (FIG. 21B).

Referring to FIG. 21B the process 1050 continues at block 1079, which directs the microprocessor 302 to determine whether the mode code has been changed to an invalid mode code, in which case the microprocessor is directed to block 1081. Block 1081 directs the microprocessor 302 to transmit an invalid mode message to the user interface device, and the process continues at block 1200 of FIG. 22A.

Block 1080 then directs the microprocessor 302 to determine whether a response has been received from the host system 317. In each of blocks 1062, 1068, and 1074 information was transmitted to the host system 317 by the controller processor circuit 400 for verification and the message received at block 1080 may thus be in response to any one of these verification request messages. If no message has been received from the host system 317, then the microprocessor 302 is directed to block 1082, which directs the microprocessor to transmit a suspend message to the user interface device. Block 1084 then directs the microprocessor 302 to determine whether an acknowledgement message has been received from the user interface device in response to the suspend message. If no acknowledgement message has been received, block 1084 directs the microprocessor 302 to block 1086 where the receive timeout/countout process is executed. If there is not yet a timeout or countout, block 1086 directs the microprocessor 302 back to block 1080. If at block 1086 the timeout/countout process has resulted in a timeout being determined, then block 1086 directs the microprocessor 302 to block 1200 of FIG. 22A, where the controller finalizes the communication session.

If at block 1080, a response is received from the host system, the process 1050 continues at block 1088, which directs the microprocessor 302 to determine whether the response is a validation of the data submitted for verification to the host system 317 has been validated by the host system. If the host system 317 has not validated the data, then the process continues at block 1090, which directs the microprocessor 302 to transmit a message requesting further payment information to the user interface device. For example, if a credit card was found to be expired, block 1090 may directs the microprocessor 302 to transmit a message requesting another credit card be selected by the user of the user interface device. Block 1092 then directs the microprocessor 302 to determine whether a wait response has been received from the user interface device, which would indicate that the user of the user interface device was in the process of selecting another card or payment method, for example. If a wait response is received, block 1092 directs the microprocessor 302 back to block 1052 (FIG. 21A). If a wait response is not received, block 1092 directs the microprocessor to block 1094, which directs the microprocessor 302 to determine whether a cancellation response has been received from the user interface device, in which case block 1094 directs the microprocessor to block 1200 of FIG. 22A for controller finalization. If a cancellation response has not been received, block 1094 directs the microprocessor 302 back to block 1090.

If at block 1088, the host validates the payment information provided, the microprocessor 302 is directed to block 1096, which directs the microprocessor 302 to transmit a message requesting confirmation of payment by the user interface device. Block 1096 may also notify the host system 317 that confirmation has been requested and is pending.

Block 1098 then directs the microprocessor 302 to determine whether a valid confirmation message has been received from the user interface device, in which case the microprocessor is directed to block 1104 and the confirmation is transmitted to the host system, which facilitates completion of the payment transaction by the host system. The process 1050 then continues at block 1106, which directs the microprocessor 302 to determine whether the payment is completed. If at block 1106, further information is still required to complete the payment, the microprocessor is directed back to block 1052 (FIG. 21A). If at block 1106 the payment is complete, the microprocessor 302 is directed to block 1200 of FIG. 22A for finalization of the communication session.

If at block 1098, the host does not validate the payment information provided, the microprocessor 302 is directed to block 1100, which directs the microprocessor to determine whether a valid wait response has been received from the user interface. If a wait response has not been received then block 110 directs the microprocessor to block 1102 and the receive timeout/countout process is executed with a countout result causing the microprocessor to be directed back to block 1200 of FIG. 22A. If there is no countout at block 1102, the microprocessor 301 is directed back to block 1096. If at block 1100, a wait response is received from the user interface device, block 1100 directs the microprocessor 302 back to block 1096.

Referring to FIG. 21C, a flowchart depicting blocks of code for directing the user interface device processor circuit 400 to interact with the controller processor circuit 300 in a payment interaction is shown at 1130. After the communication session with the controller has been established as described in FIG. 18, the message in block 920 (FIG. 18B) may include a selection of card or other payment mode provided by the user entry at block 882 (FIG. 18B). If the selected payment mode or card is not valid, the controller transmits a message at block 1090 requesting selection of an alternative payment method. The process 1130 begins at block 1132, which directs the microprocessor 402 to determine whether and invalid mode message has been received from the controller. The invalid mode message is transmitted in accordance with block 1081 of FIG. 21B when the user interface device attempts to initiate an interaction for an invalid mode of operation. If an invalid mode message has been received, the process 1130 continues at block 1172 with user interface device finalization process, which will be described in more detail below. If an invalid mode message has not been received, block 1132 directs the microprocessor 402 to block 1134. Block 1134 directs the microprocessor 402 to determine whether a further payment selection message has been received from the controller. The further payment selection message is transmitted at block 1090 of FIG. 21B when previous card or payment data provided by the user interface device was found by the host system 317 to be invalid. Block 1136 then directs the microprocessor 402 to display a list of further payment methods or cards for the user, and block 1138 directs the microprocessor to transmit a wait response to the controller. Block 1138 then directs the microprocessor 402 back to block 1140. Alternatively, if at block 1134 a further payment selection message has not been received from the controller, the microprocessor 402 is directed to block 1140.

Block 1140 directs the microprocessor 402 to determine whether a suspend message has been received from the controller and directs the microprocessor to block 1142, which directs the microprocessor to cause a display notification to be displayed on a display of the mobile phone 820. Block 1144 then directs the microprocessor 402 to transmit an acknowledgement message to the controller, and directs the microprocessor to block 1146. Alternatively, if at block 1140 a suspend message has not been received from the controller, the microprocessor 402 is directed to block 1146.

Block 1146 directs the microprocessor 402 to determine whether a user payment confirmation request has been received from the controller (i.e. block 1096 FIG. 21A), in which case the microprocessor 402 is directed to block 1148. Block 1148 directs the microprocessor 402 to cause the user confirmation request to be displayed on the display of the mobile phone 820. Block 1150 then directs the microprocessor 402 to transmit a wait response to the controller and block 1152 directs the microprocessor to transmit the confirmation response when confirmed by the user of the mobile phone 820. Block 1152 also directs the microprocessor 402 to block 1154. Alternatively, if at block 1146 a confirmation message has not been received, the microprocessor 402 is directed to block 1154.

Block 1154 directs the microprocessor 402 to determine whether a pin code request message has been received from the controller, in which case block 1156 directs the microprocessor to display a keypad graphic user interface on the display of the mobile phone 820. Block 1158 then directs the microprocessor 402 to transmit a wait response and block 1160 directs the microprocessor to transmit the pin code when entered by the user on the keypad. Block 1160 also directs the microprocessor 402 to block 1154. Alternatively, if at block 1146 a confirmation message has not been received, the microprocessor 402 is directed to block 1154.

Block 1162 directs the microprocessor 402 to determine whether a valid pin code confirmation message has been received from the controller, in which case block 1164 directs the microprocessor to process and memorize transaction details. For the example where the purchase is an electronic transit pass (E-pass), the processing may involve memorizing the E-pass identifier if receipt files have not been considered to be memorized, setting an invalidated flag for the E-pass identifier, and transmitting an acknowledgement message to the controller. The processing may further involve starting sequential receipt file retrieval process from controller, and if receipt files have been considered to be memorized by the user interface device, memorizing the entire receipt file and setting an invalidated flag for the receipt file after completion of the process. The process may also involve setting an inactivation flag for the purchase receipt and transmitting an acknowledgement message to the controller. Block 1164 also directs the microprocessor 402 to block 1166. Alternatively, if at block 1162 a valid pin code confirmation message has not been received, the microprocessor 402 is directed to block 1166.

Block 1166 then directs the microprocessor 402 to determine whether an application completed message has been received, in which case the process continues at block 1168. Block 1168 directs the microprocessor 402 to validate the memorized receipt, E-pass, or other payment result. Block 1170 then directs the microprocessor 402 to transmit an acknowledgement message to the controller. Advantageously, if the communication session is interrupted by a communication failure or other problem before the receipt is validated at block 1168 and the acknowledgement transmitted at block 1170, the transaction is not completed and the users payment method or card is not charged. Only once the receipt is validated is the transaction completed. Block 1170 further directs the microprocessor 402 to block 1172, where the microprocessor is directed to execute a user interface device finalization process. The finalization process may involve saving the communication identifier CI for the communication session for use as a verification identifier in a subsequent communication session. The finalization process may also involve clearing flags and counters etc.

### Finalization Process

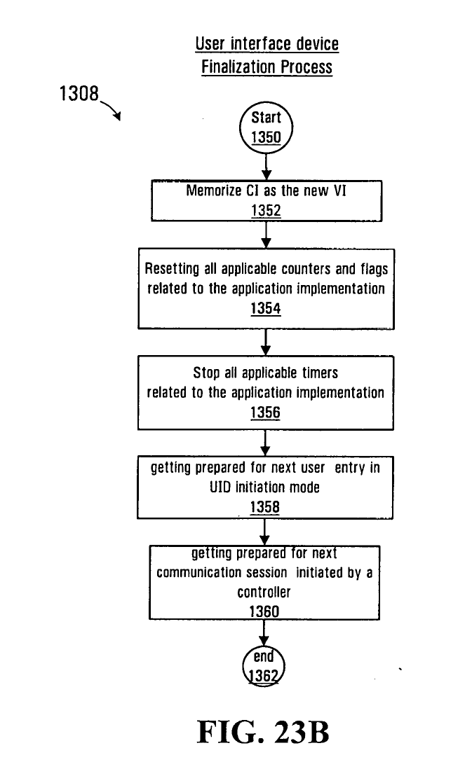

Process flowcharts depicting blocks of codes for directing the microprocessors 302 and 402 to finalize a communication session are shown in FIG. 22A, FIG. 22B, FIG. 23A and FIG. 23B.

### Multiple Transceivers

In the processor circuit embodiments shown in FIGS. 8 and 9, the controller and user interface device each have more than one transceiver. Referring back to FIG. 8 the controller processor circuit 300 has transceivers 310 and 314 that are interfaced to the transceiver bus interface 306. Referring back to FIG. 9, the user interface device processor circuit 400 has transceivers 410 and 414 that are interfaced to the transceiver bus interface 406. More than two transceivers may be interfaced to each transceiver bus interface and the transceivers may be orientated to cover different angular ranges as shown in FIG. 15 or may be differently configured transceivers as shown in FIGS. 11 and 12, for example.

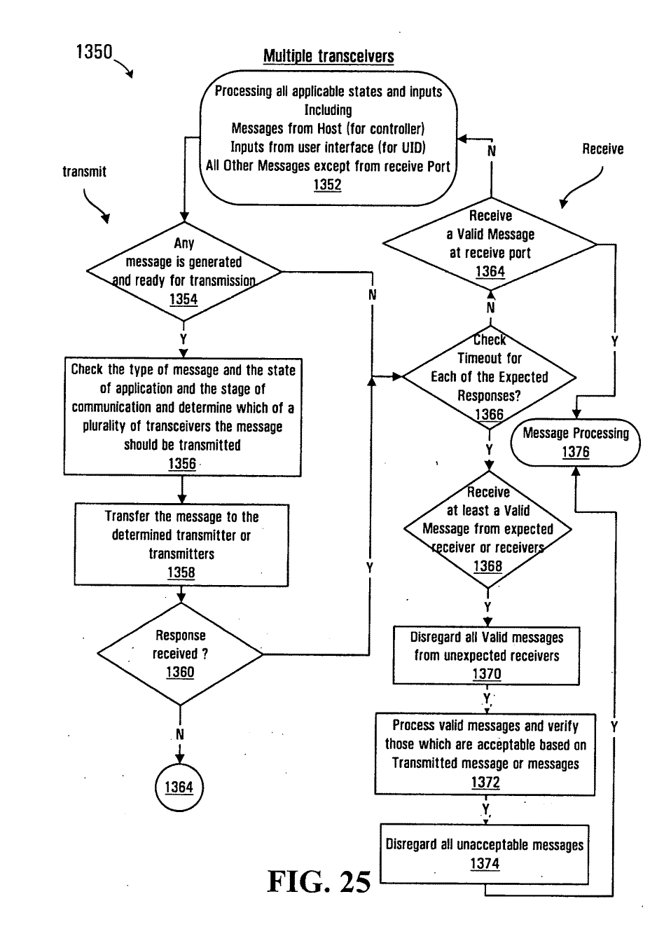

A general process flowchart including blocks of code for directing the controller processor circuit 300 to handle communications via multiple transceivers is shown in FIG. 25 at 1350. The process 1350 is also applicable to the user interface device processor circuit 400. Referring to FIG. 25, the process begins at block 1354, which directs the microprocessor 302 to determine whether a message that has been generated is ready for transmission, in which case the microprocessor is directed to block 1356. Block 1356 then directs the microprocessor 302 to select by which of a plurality of transceivers the message should be transmitted based on the state and application of the communication session. Block 1358 then directs the microprocessor 1358 to transfer the message to the selected transceiver or transceivers via the transceiver bus interface 306. Block 1360 then directs the microprocessor 302 to determine whether a response has been received from at least one of the transceivers. In this embodiment the controller is configured to expect a response from at least one of the transceivers. If a response is not received, the process continues at block 1364, which directs the microprocessor 302 to determine whether a valid message has been received. If a valid message has not been received, then block 1364 directs the microprocessor 302 to block 1352, where all applicable states and inputs including messages from a host system 317 are processed. If at block 1364, a response is not received at the receive port, the microprocessor 302 is directed to block 1376 for message processing. If at block 1360, a response is received, the microprocessor 302 is directed to block 1366, where the timeout/countout process is executed for each expected response.

If at block 1354, a message is not ready for transmission, the process continues at block 1366 and the timeout/countout process is executed. At block 1366, if there is no timeout, the microprocessor 302 is directed to block 1364. If at block 1366, if there is a timeout, the microprocessor 302 is directed to block 1368, which directs the microprocessor to receive at least one valid message from one of the transceivers or more than one message if messages were expected from multiple transceivers. The process 1350 then continues at block 1370, which directs the microprocessor 302 to disregard all valid messages from transceivers from which a response was not expected. Block 1372 then directs the microprocessor 302 to process valid messages and to verify that messages are acceptable (i.e. based on the communication identifier, dynamic identifier, and other identifiers matching the transmitted identifiers in the message that was last transmitted). Block 1374 then directs the microprocessor 302 to disregard all unacceptable message that do not have corresponding identifiers. Block 1374 also directs the microprocessor 302 to block 1376 for further message processing.

While specific embodiments of the invention have been described and illustrated, such embodiments should be considered illustrative of the invention only and not as limiting the invention as construed in accordance with the accompanying claims.

What is claimed is:

1. A method implemented on a controller for establishing a dedicated communication with a user interface device, the method comprising:
generating a communication identifier, the communication identifier being at least locally unique and having a low probability of being duplicated within a locale associated with the controller;
transmitting an initiation message including the communication identifier from the controller to the user interface device, the initiation message being operable to initiate a communication session between the controller and the user interface device, the communication identifier identifying the communication session;
receiving at least one message at the controller including a communication identifier; and
associating received messages with the communication session that have a communication identifier that corresponds to the communication identifier identifying the communication session.

2. The method of claim 1 wherein transmitting the initiation message comprises transmitting a successive plurality of initiation messages each including a respective communication identifier and further comprising initiating the communication session when a message including a communication identifier that corresponds to a previously transmitted communication identifier is received from the user interface device.

3. The method of claim 1 wherein transmitting the initiation message comprises transmitting the initiation message in response to receiving an initiation signal at the controller indicating that the user interface device is disposed to receive the initiation message.

4. The method of claim 3 wherein receiving the initiation signal comprises receiving an initiation request message from the user interface device.

5. The method of claim 4 wherein receiving the message from the user interface device at the controller comprises receiving an encrypted message at the controller, the message further including encryption information operable to facilitate decryption of the message by the controller.

6. The method of claim 5 wherein the encryption information comprises an encryption identifier identifying one of a plurality of encryption functions and wherein transmitting the initiation message comprises transmitting an initiation message including the encryption identifier provided by the user interface device.

7. The method of claim 6 further comprising transmitting at least one additional message to the user interface device, the at least one additional message including an encryption identifier identifying another one of the plurality of encryption functions operable to facilitate transmission of a further encrypted message by the user interface device back to the controller.

8. The method of claim 3 wherein receiving the initiation signal comprises receiving an initiation signal from a proximity detector disposed to detect a body entering a region, the region being defined with respect to the controller to indicate that the body is either in or about to enter into communication range.

9. The method of claim 8 wherein the body comprises a vehicle carrying the user interface device and wherein the proximity detector is disposed to detect the vehicle.

10. The method of claim 1 wherein generating the communication identifier comprises generating at least one of:
a time based identifier;
a randomly generated identifier; and
an identifier selected from a sequence of identifiers.

11. The method of claim 1 wherein the communication identifier includes at least:
a time value resolved to a fraction of a second; and
a date value.

12. The method of claim 1 wherein receiving at least one message at the controller comprises receiving a message including a verification identifier provided by the user interface device, and further comprising transmitting at least one additional message to the user interface device including the communication identifier and the verification identifier provided by the user interface device.

13. The method of claim 1 further comprising, after transmitting the initiation message, receiving a first message and a second message, the second message originating from a user interface device other than the user interface device that transmitted the first message, each of the first and second messages each including a communication identifier that corresponds to the communication identifier identifying the communication session and in response to receiving the second message, transmitting a conflict message.

14. The method of claim 13 further comprising after transmitting the conflict message:
generating a further communication identifier, the further communication identifier being at least locally unique and having a low probability of being duplicated within a locale associated with the controller; and
transmitting a further initiation message including the further communication identifier from the controller to the user interface device, the initiation message.

15. The method of claim 13 further comprising:
causing the controller to initiate a delay period, the delay period being selected from a range of delay periods;
after the delay period has expired transmitting a further initiation message to the user interface device including a verification identifier and a new randomly selected encryption identifier.

16. The method of claim 1 further comprising, after the communication session has been initiated, disregarding messages received by the controller that do not have a communication identifier that corresponds to the communication identifier identifying the communication session.

17. The method of claim 1 further comprising transmitting at least one additional message to the user interface device, the at least one additional message including information indicating that the communication session has been initiated and is in progress to facilitate a determination by other user interface devices that the message is associated with an already initiated communication session.

18. The method of claim 1 wherein transmitting the initiation message comprises transmitting an initiation message including a dynamic identifier that has a value that changes as the communication session progresses.

19. The method of claim 18 wherein transmitting the initiation message including the dynamic identifier comprises transmitting an initiation message including an identifier that changes with elapsed time.

20. The method of claim 19 wherein associating received messages comprises associating received messages with the communication session that further includes a dynamic identifier that corresponds to a current value of the dynamic identifier transmitted by the controller in the initiation message.

21. The method of claim 19 further comprising transmitting one or more additional messages to the user interface device, each additional message including a dynamic identifier having a value that is updated by the controller based on the elapsed time since a previous message was transmitted to the user interface device.

22. The method of claim 1 wherein the controller comprises an optical data transceiver and wherein transmitting the initiation message comprises transmitting an optically encoded data signal.

23. The method of claim 22 wherein transmitting the optically encoded data signal comprises transmitting signals having a radiation pattern that is constrained within a transmission angle range.

24. The method of claim 23 wherein the transmission angle range comprises a first transmission angle range and wherein the controller comprises at least one additional optical data transceiver constrained for transmission within a second transmission angle range, and wherein transmitting the optically encoded data signal comprises transmitting the optically encoded data signal using each of the optical data transceiver and the additional optical data transceiver.

25. The method of claim 22 wherein receiving the at least one message at the controller comprises receiving optically encoded data signal at the controller.

26. The method of claim 25 wherein receiving the optically encoded data signal at the controller comprises receiving a signal within a constrained acceptance angle range of the optical data transceiver.

27. The method of claim 20 wherein the controller further comprises a radio frequency (RF) data transceiver and wherein, after the communication session has been initiated, transmitting and receiving further messages using the RF data transceiver.

28. The method of claim 27 wherein transmitting the further message using the RF data transceiver comprises transmitting a further message including the verification identifier provided by the user interface device and the communication identifier provided by the controller.

29. The method of claim 27 further comprising after receiving the further messages using the RF data transceiver, receiving or transmitting at least one additional message using the optical data transceiver.

30. The method of claim 29 wherein the at least one additional message is associated with finalization of an interaction between a user of the user interface device and the controller.

31. The method of claim 1 wherein the controller is in communication with the user interface device over a wired datalink and wherein transmitting the initiation message comprises transmitting data encoded for transmission on the wired datalink.

32. The method of claim 1 wherein the controller comprises a near-field radio frequency (RF) data transceiver and wherein transmitting the initiation message comprises transmitting an initiation message encoded on a near-field RF data signal.

33. The method of claim 32 wherein receiving the at least one message at the controller comprises receiving a near-field RF data signal at the controller.

34. The method of claim 32 after the communication session has been initiated, transmitting and receiving further messages using one of:
a second radio frequency (RF) data transceiver other than the near-field RF data transceiver; and
a configuration of the radio frequency (RF) data transceiver that increases a range associated with receiving and transmitting further messages.

35. The method of claim 34 wherein transmitting and receiving further messages comprises transmitting and receiving further messages using one of:
a second radio frequency (RF) data transceiver associated with the controller; and
a second radio frequency (RF) data transceiver associated with a centralized controller in communication with the controller.

36. The method of claim 1 wherein transmitting the initiation message comprises transmitting an encrypted initiation message and wherein receiving the at least one message at the controller comprises receiving an encrypted message at the controller.

37. The method of claim 36 wherein transmitting the initiation message comprises transmitting an initiation message including encryption information, the encryption information operable to facilitate decryption of the message by the user interface device and to facilitate transmission of encrypted messages by the user interface device back to the controller.

38. The method of claim 37 wherein the encryption information comprises an encryption identifier identifying one of a plurality of encryption functions.

39. The method of claim 38 further comprising transmitting at least one additional message to the user interface device, the at least one additional message including an encryption identifier identifying another one of the plurality of encryption functions operable to facilitate transmission of a further encrypted message by the user interface device back to the controller.

40. The method of claim 38 wherein the encryption function defines encryption operations including at least one of:
a re-ordering operation for changing an order of information in the transmitted message;
a mathematical operation to be performed on data representing the information;
a combination of operations including at least one re-ordering operation and at least one mathematical operation; and
any other encryption scheme or combination of encryption schemes.

41. The method of claim 1 further comprising, after the communication session has been initiated, receiving at least one additional message associated with the communication, the at least one additional message including user interaction information associated with an interaction between a user of the user interface device and the controller.

42. The method of claim 41 wherein receiving the at least one additional message including user interaction information comprises receiving at least one of:
purchase information defining goods or services;
payment information for completing a financial transaction;
access information for obtaining access to an access controller area;
selection information providing a user selection;
user interaction information generated by the user interface device in response to user input received at a controller interface displayed on the user interface device, the controller interface being operable to provide remote access to controller functions by a user of the user interface device;
a key code entered by the user of the user interface device;
an imprinted code associated with a prior completed interaction; and
a wait request received from the user interface device while the user is entering user Input into the user interface device.

43. The method of claim 1 further comprising, after the communication session has been initiated, transmitting at least one additional message associated with the communication, the at least one additional message including controller interaction information associated with an interaction between the controller and a user of the user interface device.

44. The method of claim 43 wherein transmitting the at least one additional message including controller interaction information comprises transmitting at least one of:
state information defining a state of a system that is interfaced to the controller;
option information defining a plurality of options for selection by the user;
interface information for implementing a controller interface on the user interface device, the controller interface being operable to provide access to controller functions by a user of the user interface device;
amount information providing a transaction amount for goods or services requested by the user;
a suspend request operable to cause the user interface device to maintain the communication session while user interaction information associated with an interaction between a user of the user interface device and the controller is being processed;
an imprint, code associated with completion of the interaction for storage on the user interface device;
fixed personal info and card data, payment, royalty, access, key FOB, membership, Id cards, healthcare cards, driving license;
modifiable health condition;
temporary access data;
single use e-ticket and multiple use e-Pass;
single use e-ticket and multiple use e-Pass associated with real-time (UID) attendance monitoring;
e-money exchangeable and usable in local mode with no centrally fraud control;
e-money provided by a vendor and usable for the same vendor with no centrally fraud control in one transaction total e-money presented, and validated e-ticket provided and the value of the e-money will be reduced for the payable amount of the issued e-ticket;
an e-receipt;
pin codes and password, which would be better to be imprinted to a UID by a controller after the pin codes or password successfully approved by the controller or by the central system, which are associated with the controller;
a key-code request for initiating entry of a key-code by the user of the user interface device;
an access authorization or access denial provided by the controller in response to access information provided by the user interface device; and
an access authorization or access denial provided by an access control system in communication with the controller and relayed by the controller to the user in response to access provided by the user interface device.

45. A non-transitory computer readable medium encoded with codes for directing a processor circuit of the controller to implement the method of any one of claims 1 to 44.

46. A controller apparatus for establishing a dedicated communication with a user interface device, the apparatus comprising:
an identifier generator operable to generate a communication identifier, the communication identifier being at least locally unique and having a low probability of being duplicated within a locale associated with the controller;
a transceiver operable to transmit an initiation message including the communication identifier to the user interface device, the initiation message being operable to initiate a communication session between the controller and the user interface device, the communication identifier identifying the communication session;
wherein the transceiver is operable to receive at least one message including a communication identifier; and
wherein the controller is operable to associate received messages with the communication session that have a communication identifier that corresponds to the communication identifier identifying the communication session.

47. A method implemented on a user interface device for establishing a communication with a controller, the method comprising:
receiving an initiation message from the controller at the user interface device, the initiation message including a communication identifier and being operable to initiate a communication session between the controller and the user interface device, the communication identifier being at least locally unique and having a low probability of being duplicated within a locale associated with the controller, the communication identifier identifying the communication session; and
transmitting at least one message to the controller including a communication identifier corresponding to communication identifier in the initiation message.

48. The method of claim 47 wherein transmitting at least one message to the controller comprises:
generating an at least locally unique verification identifier having a low probability of being duplicated within a locale associated with the controller;
transmitting a message including the verification identifier, and further comprising receiving at least one additional message from the controller including the communication identifier and the verification identifier, and terminating the communication session if the verification identifier does not correspond to the verification identifier generated by the user interface device.

49. The method of claim 48 wherein generating the verification identifier comprises generating one of:
a time based identifier;
a randomly generated identifier;
an identifier selected from a sequence of identifiers; and
reading a communication identifier associated with a previous communication session.

50. The method of claim 48 further comprising transmitting at least one subsequent message to the controller that includes the communication identifier but does not include the verification identifier.

51. The method of claim 47 wherein receiving the initiation message comprises receiving an initiation message including a dynamic identifier that has a value that changes as the communication session progresses and wherein transmitting the at least one message comprises transmitting at least one message to the controller that includes the dynamic identifier.

52. The method of claim 47 further comprising receiving a conflict message from the controller, the conflict message indicating that more then one user interface device have attempted to establish a communication session with the controller and further comprising:
causing the user interface device to initiate a delay period, the delay period being selected from a range of delay periods;
after the delay period has expired transmitting a further message to the controller including a communication identifier corresponding to the further communication identifier in the further initiation message.

53. The method of claim 48 further comprising receiving an encrypted conflict message from the controller the encrypted conflict message including encryption information, the encryption information operable to facilitate decryption of the conflict message by the user interface device, and further comprising one of:
if the encryption information permits the conflict message to be decrypted to reveal a verification identifier in the conflict message that corresponds to the verification identifier generated by the user interface device, continuing the communication session with the controller; and
if the encryption information does not permit the conflict message to be decrypted to reveal a verification identifier in the conflict message that corresponds to the verification identifier generated by the user interface device, discontinuing the communication session with the controller.

54. The method of claim 47 further comprising determining whether the initiation message received from the controller is a valid message, and further comprising transmitting a user interface device conflict message to the controller when the message is not a valid message.

55. The method of claim 54 wherein determining whether the initiation message received from the controller is a valid message comprises at least one of:
determining that an end of transmission element is missing; and
determining that a verification identifier in the initiation message does not correspond with a verification identifier provided by the user interface device in a previous message transmitted to the controller.

56. The method of claim 47 wherein the user interface device comprises an optical data transceiver and wherein transmitting the at least one message to the controller comprises transmitting an optically encoded data signal.

57. The method of claim 56 wherein transmitting the optically encoded data signal comprises transmitting signals having a radiation pattern that is constrained within a transmission angle range.

58. The method of claim 57 wherein the transmission angle range comprises a first transmission angle range and wherein the user interface device comprises at least one additional optical data transceiver constrained for transmission within a second transmission angle range, and wherein transmitting the optically encoded data signal comprises transmitting the optically encoded data signal using each of the optical data transceiver and the additional optical data transceiver.

59. The method of claim 56 wherein the user interface device further comprises a radio frequency (RF) data transceiver and wherein, after the communication session has been initiated, transmitting and receiving further messages using the RF data transceiver.

60. The method of claim 59 wherein transmitting the further message using the RF data transceiver comprises:
generating an at least locally unique verification identifier having a low probability of being duplicated within a locale associated with the controller;
transmitting the further message including the verification identifier.

61. The method of claim 59 further comprising after receiving the further messages using the RF data transceiver, receiving or transmitting at least one additional message using the optical data transceiver.

62. The method of claim 61 wherein the at least one additional message is associated with finalization of an interaction between a user of the user interface device and the controller.

63. The method of claim 47 wherein the user interface device is in communication with the controller over a wired datalink and wherein receiving the initiation message comprises receiving data encoded for transmission on the wired datalink.

64. The method of claim 47 wherein the user interface device comprises a near-field radio frequency (RF) data transceiver and wherein receiving the initiation message comprises receiving an initiation message encoded on a near-field RF data signal.

65. The method of claim 64 after the communication session has been initiated, transmitting and receiving further messages using one of:
a second radio frequency (RF) data transceiver other than the near-field RF data transceiver; and
a configuration of the radio frequency (RF) data transceiver that increases a range associated with receiving and transmitting further messages.

66. The method of claim 47 wherein receiving the initiation message comprises receiving an encrypted initiation message including encryption information operable to facilitate decryption of the message by the user interface device and wherein transmitting the at least one message comprises transmitting at least one message encrypted using the encryption information provided by the controller.

67. The method of claim 66 wherein the encryption information comprises an encryption identifier identifying one of a plurality of encryption functions.

68. The method of claim 47 wherein transmitting the message comprises transmitting a message including user interaction information associated with an interaction between a user of the user interface device and the controller.

69. The method of claim 68 wherein transmitting the message including user interaction information comprises transmitting at least one of:
purchase information defining goods or services;
payment information for completing a financial transaction;
access information for obtaining access to an access controller area;
selection information providing a user selection;
user interaction information generated by the user interface device in response to user input received at a controller interface displayed on the user interface device, the controller interface being operable to provide remote access to controller functions by a user of the user interface device;
a key code entered by the user of the user interface device;
an imprinted code associated with a prior completed interaction; and
a wait request transmitted to the controller while the user is entering user input into the user interface device.

70. The method of claim 47 further comprising receiving at least one additional message from the controller, the at least one additional message including at least one of:
state information defining a state of a system that is interfaced to the controller;
option information defining a plurality of options for selection by the user;
interface information for implementing a controller interface on the user interface device, the controller interface being operable to provide access to controller functions by a user of the user interface device;
amount information providing a transaction amount for goods or services requested by the user;
a suspend request operable to cause the user interface device to maintain the communication session while user interaction information associated with an interaction between a user of the user interface device and the controller is being processed;
an imprint code associated with completion of the interaction for storage on the user interface device;
a key-code request for initiating entry of a key-code by the user of the user interface device;
an access authorization or access denial provided by the controller in response to access information provided by the user interface device; and
an access authorization or access denial provided by an access control system in communication with the controller and relayed by the controller to the user in response to access provided by the user interface device.

71. A non-transitory computer readable medium encoded with codes for directing a processor circuit of the user interface device to implement the method of any one of claims 47 to 70.

72. A user interface device for establishing a communication with a controller, the user interface device comprising:
a transceiver operable to receive an initiation message from the controller, the initiation message including a communication identifier and being operable to initiate a communication session between the controller and the user interface device, the communication identifier being at least locally unique and having a low probability of being duplicated within a locale associated with the controller, the communication identifier identifying the communication session; and
wherein the transceiver is operable to transmit at least one message to the controller including a communication identifier corresponding to communication identifier in the initiation message.

73. An establishment of substitutive or complementary (parallel) link or links by communication ID:
just by communication ID
additionally to device ID (Bluetooth or Wi-Fi)
a) Multiple pulling applications are supportable by a UID and a controller
b) Multiple pulling applications can be sequentially implemented through the continuation of a continuous communication session
c) in UID initiation mode: a UID can propose a pulling application then other applications can be proposed by UID or controller
d) the supportability of a proposed application by one party can be realized by the other party through the first 3 steps of initiation
e) disregarding an initial and unsupportable application will be implemented with a proper notification associated with a communication cancelation process (LIT will not change)
f) disregarding a complementary unsupportable application will be implemented with a proper notification associated with a communication finalization process (LIT will change)
g) 2 types of applications:
h) at least one User entry through UID interface or controller interface is required
i) Fully automated application (mirror interfacing just for user notification)
j) a Pulling application can resulted to the exchange of a new imprinted code with a previously imprinted code (in UID) with no conflict or lose of primary code or secondary code and also with no unfavourable systematic code mismatch
k) a UID which support a proposed application by a controller has the intelligence to notify the controller about not having a pulled code of the user of the controller
i. (as an example a UID, which supports the loyalty card memorization [wireless loyalty card imprint] after the establishment of the respective and supported communication session can verify the vendor of a controller, which has not previously provided any vendor's loyalty card and then will disregard the pulling application. that might be associated with a further pulling application [e.g. payment by a payment card] or alternatively associated with a finalization process. the mentioned situations can occur through any of the controllers, which might be used for the same application by the same vendor.
l) supportable pulling applications by controllers and UIDs can be extended through Firmware upgrade, which resulted to the extension of main-state-processing of the upgraded controllers and UIDs. the vendors and users can exert their allowed Firmware upgrades, with no possible access neither to the encryption and security features nor the automatic connection, dedication or reliability features.
m) support centre and Central activation and deactivation (offline-online)
